(19) United States
(12) Patent Application Publication
(10) Pub. No.: US 2026/0291750 A1
(43) Pub. Date: Sep. 24, 2026

(54) System, Method, and Computer Program Product for Generating a Cryptographically Verifiable Property-Associated Electronic Device Metadata Record for a Real Estate Property

(71) Applicant: CleanSL8, Inc., Pittsburgh, PA (US)

(72) Inventors: Christian Musuraca, Pittsburgh, PA (US); Erik Ross, Pittsburgh, PA (US)

(21) Appl. No.: 19/571,858

(22) Filed: Mar. 19, 2026

Related U.S. Application Data
(60) Provisional application No. 63/774,270, filed on Mar. 19, 2025.
(60) Provisional application No. 63/790,968, filed on Apr. 18, 2025.

(51) Int. Cl. H04L 9/32; G06F 21/64; G06Q 50/16; H04L 9/06

(52) U.S. Cl. CPC H04L 9/3247; G06F 21/64; G06Q 50/16; H04L 9/0643

(57) ABSTRACT

An example method for generating a cryptographically verifiable property-associated electronic device metadata record for a real estate property may include receiving a structured device dataset associated with one or more property-associated electronic devices located at the real estate property, identifying a unique property identifier for the real estate property, and generating a unified property metadata profile including the unique property identifier and the structured device dataset. The method may further include providing the unified property metadata profile, receiving user input, generating a confirmed structured device dataset and a confirmed unified property metadata profile, generating a cryptographic binding value for the confirmed unified property metadata profile, generating a digital signature over the cryptographic binding value to produce a cryptographic attestation, and storing the confirmed unified property metadata profile and the cryptographic attestation for subsequent validation of integrity of both the confirmed structured device dataset and the unique property identifier.

### CROSS REFERENCE TO RELATED APPLICATIONS

The present application claims the benefit of U.S. Patent Provisional Application Ser. No. 63/774,270, filed Mar. 19, 2025, and U.S. Provisional Application Ser. No. 63/790,968, filed Apr. 18, 2025, the entire disclosures of which are hereby incorporated by reference in their entirety.

### BACKGROUND

### 1. Technical Field

This disclosure relates generally to systems and methods for generating cryptographically verifiable records and, in non-limiting embodiments or aspects, to systems, methods, and computer program products for hardware-based wireless device discovery, deterministic property identifier generation, and cryptographic binding and attestation of device metadata for a cryptographically verifiable record.

### 2. Technical Considerations

Modern real estate properties increasingly include networked and wireless electronic devices that emit wireless signals and maintain persistent associations with user accounts. However, there is no reliable mechanism for automatically detecting property-associated electronic devices at a physical property and/or generating a verifiable record of such devices that can be bound to a property identity.

### SUMMARY

Accordingly, provided are improved systems, methods, and computer program products for generating a cryptographically verifiable property-associated electronic device metadata record for a real estate property.

According to non-limiting embodiments or aspects, provided is method for generating a cryptographically verifiable property-associated electronic device metadata record for a real estate property, including: receiving, with at least one processor, a structured device dataset including device metadata associated with one or more property-associated electronic devices located at the real estate property; identifying or retrieving, with the at least one processor, a unique property identifier for the real estate property; generating, with the at least one processor, a unified property metadata profile including the unique property identifier for the real estate property and the structured device dataset; providing, with the at least one processor, the unified property metadata profile to at least one user device; receiving, with the at least one processor, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof; generating, with the at least one processor, based on the user input, a confirmed structured device dataset and a confirmed unified property metadata profile including the confirmed structured device dataset and the unique property identifier; generating, with the at least one processor, a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value; generating, with the at least one processor, a digital signature over the cryptographic binding value for the confirmed unified property metadata profile using a private cryptographic key to produce a cryptographic attestation that binds the confirmed structured device dataset to the unique property identifier; and storing, with the at least one processor, the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

In some non-limiting embodiments or aspects, the method further includes: deploying a hardware scanner node at the real estate property, the hardware scanner node including at least one wireless communication interface configured to receive wireless signal emissions within a reception range of the at least one wireless communication interface; scanning, with the hardware scanner node using the at least one wireless communication interface, for wireless signal emissions associated with one or more property-associated electronic devices located at the real estate property; detecting, with the hardware scanner node, the one or more property-associated electronic devices based on the received wireless signal emissions; extracting, with the hardware scanner node from the received wireless signal emissions, device metadata associated with the one or more property-associated electronic devices; generating, with the hardware scanner node, the structured device dataset including the device metadata associated with the one or more property-associated electronic devices; and providing, with the hardware scanner node, the structured device dataset to the at least one processor.

In some non-limiting embodiments or aspects, the hardware scanner node is configured to extract the device metadata and transmit the structured device dataset including the device metadata to the at least one processor without performing, on the device metadata, a local address normalization operation, a local property identity resolution operation, a local device fingerprint matching operation, or any combination thereof, wherein the at least one processor performs the address normalization operation, the property identity resolution operation, and the device fingerprint matching operation on the device metadata included in the structured device dataset received from the hardware scanner node, and wherein the hardware scanner node initiates scanning for the wireless signal emissions only after receiving, from the at least one processor, a session authorization confirmation associated with an authorized capture session for the real estate property, such that scanning by the hardware scanner node is bounded to the authorized capture session.

In some non-limiting embodiments or aspects, the hardware scanner node comprises a sensor array device configured to capture raw audio data, raw RF signal data, and raw optical data associated with the real estate property and to provide, to the at least one processor, the raw audio data, the raw RF signal data, the raw optical data, and/or device metadata derived therefrom without performing, at the hardware scanner node, the local address normalization operation, the local property identity resolution operation, the local device fingerprint matching operation, or any combination thereof, wherein the scanning for the wireless signal emissions comprises a first authorization stage in which a property participant grants network access to the hardware scanner node thereby enabling RF-based detection of the wireless signal emissions, wherein the user input comprises a second authorization stage in which the property participant confirms the structured device dataset prior to generation of the cryptographic attestation, and wherein the at least one processor activates optical data capture as a primary or supplemental capture modality when RF-based detection of the wireless signal emissions is unavailable or insufficient.

In some non-limiting embodiments or aspects the hardware scanner node includes a plurality of wireless communication interfaces, wherein each wireless communication interface of the plurality of wireless communication interfaces is configured to receive a different type of wireless signal emission, wherein scanning for the wireless signal emissions, detecting the one or more property-associated electronic devices, and extracting the device metadata are performed by the hardware scanner node over a plurality of discovery cycles within a defined verification window using at least two wireless communication interfaces of the plurality of wireless communication interfaces, and wherein each property-associated electronic device of the one or more property-associated electronic devices is included in the structured device dataset only upon (i) detection of corresponding wireless signal emissions associated with that property-associated electronic device in at least a threshold number of the plurality of discovery cycles or (ii) a confidence value derived from the detected wireless signal emissions associated with that property-associated electronic device across the plurality of discovery cycles satisfying a predefined threshold.

In some non-limiting embodiments or aspects, receiving, with the at least one processor, the structured device dataset includes: receiving the structured device dataset together with a scanner attestation, the scanner attestation including (i) a scanner integrity value generated by applying a cryptographic hash function to scanner node state information associated with the hardware scanner node and (ii) a scanner digital signature over the scanner integrity value; and validating the scanner digital signature using a corresponding scanner public key to generate a scanner validation result, and wherein the unified property metadata profile is generated in response to the scanner validation result indicating that the scanner digital signature is valid.

In some non-limiting embodiments or aspects, the method further includes: generating, with the at least one processor, the unique property identifier for the real estate property, wherein the unique property identifier for the real estate property is generated before deploying the hardware scanner node at the real estate property and independently of scanning, with the hardware scanner node using the at least one wireless communication interface, for the wireless signal emissions associated with the one or more property-associated electronic devices located at the real estate property.

In some non-limiting embodiments or aspects, generating, with the at least one processor, the unique property identifier for the real estate property includes: obtaining property address data associated with the real estate property; applying a salting operation to the property address data to generate salted property address data; and processing the salted property address data using a deterministic key generation algorithm to produce the unique property identifier, wherein processing the salted property address data using the deterministic key generation algorithm includes applying a cryptographic one-way function or a key derivation function (KDF) to the salted property address data to produce the unique property identifier, and wherein applying the salting operation includes combining the property address data with a salt value, the salt value being derived from at least one of a platform secret, a per-property secret, or a version-specific secret.

In some non-limiting embodiments or aspects, generating, with the at least one processor, the unique property identifier for the real estate property includes generating, with the at least one processor, a plurality of unique property identifiers for a plurality of real estate properties by: obtaining, for each real estate property of the plurality of real estate properties, corresponding property address data associated with that real estate property; applying, for each real estate property of the plurality of real estate properties, the salting operation to the corresponding property address data associated with that real estate property to generate corresponding salted property address data for that real estate property; processing, for each real estate property of the plurality of real estate properties, the corresponding salted property address data for that real estate property using the deterministic key generation algorithm to produce a corresponding unique property identifier for that real estate property; and storing, in a data repository, the plurality of unique property identifiers for the plurality of real estate properties, wherein the corresponding unique property identifier for each real estate property is stored in association with the corresponding property address data associated with that real estate property.

In some non-limiting embodiments or aspects, storing, in the data repository, the plurality of unique property identifiers for the plurality of real estate properties comprises pre-instantiating, the plurality of unique property identifiers as a property identity infrastructure, the storing further including: generating a plurality of regional Merkle roots representing respective portions of data associated with the plurality of unique property identifiers; pinning data corresponding to the plurality of regional Merkle roots to a content-addressed distributed file system to generate a corresponding plurality of content identifiers; and anchoring the corresponding plurality of content identifiers to a blockchain using a corresponding plurality of blockchain transaction hashes, such that the property identity infrastructure is cryptographically committed in a tamper-evident and time-verifiable manner.

In some non-limiting embodiments or aspects, generating, with the at least one processor, the unique property identifier further includes: generating canonicalized property address data by normalizing the property address data according to one or more normalization rules; obtaining geospatial location data associated with the real estate property; and generating normalized geospatial location data by converting the geospatial location data to a predetermined precision, wherein applying the salting operation includes applying the salting operation to a combination of the canonicalized property address data and the normalized geospatial location data to generate the salted property address data, wherein generating the canonicalized property address data includes parsing the property address data into a plurality of hierarchical location components and arranging the plurality of hierarchical location components in a predetermined hierarchical order to generate a hierarchical location encoding, and wherein applying the salting operation includes applying the salting operation to a combination of the hierarchical location encoding and the normalized geospatial location data to generate the salted property address data.

In some non-limiting embodiments or aspects, generating the cryptographic binding value further includes: generating a canonical binding input corresponding to the confirmed unified property metadata profile by combining a canonical representation of the unique property identifier and a canonical representation of the confirmed structured device dataset in a predetermined ordering; excluding one or more non-deterministic fields that vary across transmissions while including the unique property identifier and the confirmed structured device dataset; and applying the cryptographic hash function to the canonical binding input to generate the cryptographic binding value.

In some non-limiting embodiments or aspects, storing the confirmed unified property metadata profile and the cryptographic attestation further includes: storing the confirmed unified property metadata profile and the cryptographic attestation as an immutable point-in-time artifact in an append-only storage configuration; and maintaining a tamper-evident history of stored point-in-time artifacts associated with the unique property identifier.

In some non-limiting embodiments or aspects, generating, with the at least one processor, the cryptographic binding value further includes: generating one or more component digests for one or more portions of the confirmed structured device dataset; combining the one or more component digests into an aggregate digest; and generating the cryptographic binding value based on the aggregate digest and the unique property identifier.

In some non-limiting embodiments or aspects, the user input includes a participant confirmation event including an affirmative confirmation action by a property participant confirming the structured device dataset, and wherein the cryptographic attestation is generated only after receipt of the participant confirmation event.

In some non-limiting embodiments or aspects, the participant confirmation event includes a confirmation timestamp recording a date and time of the affirmative confirmation action and a confirmation method identifier identifying a modality of the affirmative confirmation action, and wherein the confirmation timestamp and the confirmation method identifier are included as data fields within the cryptographic attestation and are cryptographically bound thereto such that subsequent validation of the digital signature verifies the confirmation timestamp and the confirmation method identifier.

In some non-limiting embodiments or aspects, the receiving of the structured device dataset, the generating of the confirmed structured device dataset and the confirmed unified property metadata profile, the generating of the cryptographic attestation, and the storing of the confirmed unified property metadata profile and the cryptographic attestation define a first capture session associated with the unique property identifier, and wherein a subsequent capture session associated with the same unique property identifier includes subsequently receiving a subsequent structured device dataset associated with the one or more property-associated electronic devices located at the real estate property, generating a subsequent confirmed structured device dataset and a subsequent confirmed unified property metadata profile including the same unique property identifier, generating a subsequent cryptographic attestation for the subsequent confirmed unified property metadata profile, and storing the subsequent confirmed unified property metadata profile and the subsequent cryptographic attestation, wherein the subsequent cryptographic attestation includes a reference to, or a cryptographic hash of, the cryptographic attestation, such that the subsequent cryptographic attestation is cryptographically linked to the cryptographic attestation and the cryptographic attestation and the subsequent cryptographic attestation form a verifiable lifecycle record associated with the unique property identifier across ownership transfers of the real estate property.

In some non-limiting embodiments or aspects, a capture session associated with the structured device dataset comprises a first authorization stage in which a property participant grants network access to a hardware scanner node thereby enabling RF-based detection of wireless signal emissions, and a second authorization stage in which the property participant confirms the structured device dataset prior to generation of the cryptographic attestation.

According to some non-limiting embodiments or aspects, provided is a system for generating a cryptographically verifiable property-associated electronic device metadata record for a real estate property, including: at least one processor configured to: receive a structured device dataset including device metadata associated with one or more property-associated electronic devices located at the real estate property; identify or retrieve a unique property identifier for the real estate property; generate a unified property metadata profile including the unique property identifier and the structured device dataset; provide the unified property metadata profile to at least one user device; receive, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof; generate, based on the user input, a confirmed structured device dataset and a confirmed unified property metadata profile including the confirmed structured device dataset and the unique property identifier; generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value; generate a digital signature over the cryptographic binding value for the confirmed unified property metadata profile using a private cryptographic key to produce a cryptographic attestation that binds the confirmed structured device dataset to the unique property identifier; and store the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

In some non-limiting embodiments or aspects, the method further includes: a hardware scanner node deployed at the real estate property, the hardware scanner node including at least one wireless communication interface configured to receive wireless signal emissions within a reception range of the at least one wireless communication interface, wherein the hardware scanner node is configured to: scan, using the at least one wireless communication interface, for wireless signal emissions associated with one or more property-associated electronic devices located at the real estate property; detect the one or more property-associated electronic devices based on the received wireless signal emissions; extract, from the received wireless signal emissions, device metadata associated with the one or more property-associated electronic devices; generate the structured device dataset including the device metadata associated with the one or more property-associated electronic devices; and provide the structured device dataset to the at least one processor.

According to some non-limiting embodiments or aspects, provided is a computer program product including at least one non-transitory computer-readable medium including program instructions for generating a cryptographically verifiable property-associated electronic device metadata record for a real estate property that, when executed by at least one processor, cause the at least one processor to: receive a structured device dataset including device metadata associated with one or more property-associated electronic devices located at the real estate property; identify or retrieve a unique property identifier for the real estate property; generate a unified property metadata profile including the unique property identifier and the structured device dataset; provide the unified property metadata profile to at least one user device; receive, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof; generate, based on the user input, a confirmed structured device dataset and a confirmed unified property metadata profile including the confirmed structured device dataset and the unique property identifier; generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value; generate a digital signature over the cryptographic binding value for the confirmed unified property metadata profile using a private cryptographic key to produce a cryptographic attestation that binds the confirmed structured device dataset to the unique property identifier; and store the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

Further non-limiting embodiments or aspects are set forth in the following numbered clauses:

Clause 1: A method for generating a cryptographically verifiable property-associated electronic device metadata record for a real estate property, comprising: receiving, with at least one processor, a structured device dataset including device metadata associated with one or more property-associated electronic devices located at the real estate property; identifying or retrieving, with the at least one processor, a unique property identifier for the real estate property; generating, with the at least one processor, a unified property metadata profile including the unique property identifier for the real estate property and the structured device dataset; providing, with the at least one processor, the unified property metadata profile to at least one user device; receiving, with the at least one processor, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof; generating, with the at least one processor, based on the user input, a confirmed structured device dataset and a confirmed unified property metadata profile including the confirmed structured device dataset and the unique property identifier; generating, with the at least one processor, a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value; generating, with the at least one processor, a digital signature over the cryptographic binding value for the confirmed unified property metadata profile using a private cryptographic key to produce a cryptographic attestation that binds the confirmed structured device dataset to the unique property identifier; and storing, with the at least one processor, the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

Clause 2: The method of clause 1, further comprising: deploying a hardware scanner node at the real estate property, the hardware scanner node including at least one wireless communication interface configured to receive wireless signal emissions within a reception range of the at least one wireless communication interface; scanning, with the hardware scanner node using the at least one wireless communication interface, for wireless signal emissions associated with one or more property-associated electronic devices located at the real estate property; detecting, with the hardware scanner node, the one or more property-associated electronic devices based on the received wireless signal emissions; extracting, with the hardware scanner node from the received wireless signal emissions, device metadata associated with the one or more property-associated electronic devices; generating, with the hardware scanner node, the structured device dataset including the device metadata associated with the one or more property-associated electronic devices; and providing, with the hardware scanner node, the structured device dataset to the at least one processor.

Clause 3: The method of clause 1 or 2, wherein the hardware scanner node is configured to extract the device metadata and transmit the structured device dataset including the device metadata to the at least one processor without performing, on the device metadata, a local address normalization operation, a local property identity resolution operation, a local device fingerprint matching operation, or any combination thereof, wherein the at least one processor performs the address normalization operation, the property identity resolution operation, and the device fingerprint matching operation on the device metadata included in the structured device dataset received from the hardware scanner node, and wherein the hardware scanner node initiates scanning for the wireless signal emissions only after receiving, from the at least one processor, a session authorization confirmation associated with an authorized capture session for the real estate property, such that scanning by the hardware scanner node is bounded to the authorized capture session.

Clause 4: The method of any of clauses 1-3, wherein the hardware scanner node comprises a sensor array device configured to capture raw audio data, raw RF signal data, and raw optical data associated with the real estate property and to provide, to the at least one processor, the raw audio data, the raw RF signal data, the raw optical data, and/or device metadata derived therefrom without performing, at the hardware scanner node, the local address normalization operation, the local property identity resolution operation, the local device fingerprint matching operation, or any combination thereof, wherein the scanning for the wireless signal emissions comprises a first authorization stage in which a property participant grants network access to the hardware scanner node thereby enabling RF-based detection of the wireless signal emissions, wherein the user input comprises a second authorization stage in which the property participant confirms the structured device dataset prior to generation of the cryptographic attestation, and wherein the at least one processor activates optical data capture as a primary or supplemental capture modality when RF-based detection of the wireless signal emissions is unavailable or insufficient.

Clause 5: The method of any of clauses 1-4, wherein the hardware scanner node includes a plurality of wireless communication interfaces, wherein each wireless communication interface of the plurality of wireless communication interfaces is configured to receive a different type of wireless signal emission, wherein scanning for the wireless signal emissions, detecting the one or more property-associated electronic devices, and extracting the device metadata are performed by the hardware scanner node over a plurality of discovery cycles within a defined verification window using at least two wireless communication interfaces of the plurality of wireless communication interfaces, and wherein each property-associated electronic device of the one or more property-associated electronic devices is included in the structured device dataset only upon (i) detection of corresponding wireless signal emissions associated with that property-associated electronic device in at least a threshold number of the plurality of discovery cycles or (ii) a confidence value derived from the detected wireless signal emissions associated with that property-associated electronic device across the plurality of discovery cycles satisfying a predefined threshold.

Clause 6: The method of any of clauses 1-5, wherein receiving, with the at least one processor, the structured device dataset includes: receiving the structured device dataset together with a scanner attestation, the scanner attestation including (i) a scanner integrity value generated by applying a cryptographic hash function to scanner node state information associated with the hardware scanner node and (ii) a scanner digital signature over the scanner integrity value; and validating the scanner digital signature using a corresponding scanner public key to generate a scanner validation result, and wherein the unified property metadata profile is generated in response to the scanner validation result indicating that the scanner digital signature is valid.

Clause 7: The method of any of clauses 1-6, further comprising: generating, with the at least one processor, the unique property identifier for the real estate property, wherein the unique property identifier for the real estate property is generated before deploying the hardware scanner node at the real estate property and independently of scanning, with the hardware scanner node using the at least one wireless communication interface, for the wireless signal emissions associated with the one or more property-associated electronic devices located at the real estate property.

Clause 8: The method of any of clauses 1-7, wherein generating, with the at least one processor, the unique property identifier for the real estate property includes: obtaining property address data associated with the real estate property; applying a salting operation to the property address data to generate salted property address data; and processing the salted property address data using a deterministic key generation algorithm to produce the unique property identifier, wherein processing the salted property address data using the deterministic key generation algorithm includes applying a cryptographic one-way function or a key derivation function (KDF) to the salted property address data to produce the unique property identifier, and wherein applying the salting operation includes combining the property address data with a salt value, the salt value being derived from at least one of a platform secret, a per-property secret, or a version-specific secret.

Clause 9: The method of any of clauses 1-8, wherein generating, with the at least one processor, the unique property identifier for the real estate property includes generating, with the at least one processor, a plurality of unique property identifiers for a plurality of real estate properties by: obtaining, for each real estate property of the plurality of real estate properties, corresponding property address data associated with that real estate property; applying, for each real estate property of the plurality of real estate properties, the salting operation to the corresponding property address data associated with that real estate property to generate corresponding salted property address data for that real estate property; processing, for each real estate property of the plurality of real estate properties, the corresponding salted property address data for that real estate property using the deterministic key generation algorithm to produce a corresponding unique property identifier for that real estate property; and storing, in a data repository, the plurality of unique property identifiers for the plurality of real estate properties, wherein the corresponding unique property identifier for each real estate property is stored in association with the corresponding property address data associated with that real estate property.

Clause 10: The method of any of clauses 1-9, wherein storing, in the data repository, the plurality of unique property identifiers for the plurality of real estate properties comprises pre-instantiating, the plurality of unique property identifiers as a property identity infrastructure, the storing further including: generating a plurality of regional Merkle roots representing respective portions of data associated with the plurality of unique property identifiers; pinning data corresponding to the plurality of regional Merkle roots to a content-addressed distributed file system to generate a corresponding plurality of content identifiers; and anchoring the corresponding plurality of content identifiers to a blockchain using a corresponding plurality of blockchain transaction hashes, such that the property identity infrastructure is cryptographically committed in a tamper-evident and time-verifiable manner.

Clause 11: The method of any of clauses 1-10, wherein generating, with the at least one processor, the unique property identifier further includes: generating canonicalized property address data by normalizing the property address data according to one or more normalization rules; obtaining geospatial location data associated with the real estate property; and generating normalized geospatial location data by converting the geospatial location data to a predetermined precision, wherein applying the salting operation includes applying the salting operation to a combination of the canonicalized property address data and the normalized geospatial location data to generate the salted property address data, wherein generating the canonicalized property address data includes parsing the property address data into a plurality of hierarchical location components and arranging the plurality of hierarchical location components in a predetermined hierarchical order to generate a hierarchical location encoding, and wherein applying the salting operation includes applying the salting operation to a combination of the hierarchical location encoding and the normalized geospatial location data to generate the salted property address data.

Clause 12: The method of any of clauses 1-11, wherein generating the cryptographic binding value further includes: generating a canonical binding input corresponding to the confirmed unified property metadata profile by combining a canonical representation of the unique property identifier and a canonical representation of the confirmed structured device dataset in a predetermined ordering; excluding one or more non-deterministic fields that vary across transmissions while including the unique property identifier and the confirmed structured device dataset; and applying the cryptographic hash function to the canonical binding input to generate the cryptographic binding value.

Clause 13: The method of any of clauses 1-12, wherein storing the confirmed unified property metadata profile and the cryptographic attestation further includes: storing the confirmed unified property metadata profile and the cryptographic attestation as an immutable point-in-time artifact in an append-only storage configuration; and maintaining a tamper-evident history of stored point-in-time artifacts associated with the unique property identifier.

Clause 14: The method of any of clauses 1-13, wherein generating, with the at least one processor, the cryptographic binding value further includes: generating one or more component digests for one or more portions of the confirmed structured device dataset; combining the one or more component digests into an aggregate digest; and generating the cryptographic binding value based on the aggregate digest and the unique property identifier.

Clause 15: The method of any of clauses 1-14, wherein the user input includes a participant confirmation event including an affirmative confirmation action by a property participant confirming the structured device dataset, and wherein the cryptographic attestation is generated only after receipt of the participant confirmation event.

Clause 16: The method of any of clauses 1-15, wherein the participant confirmation event includes a confirmation timestamp recording a date and time of the affirmative confirmation action and a confirmation method identifier identifying a modality of the affirmative confirmation action, and wherein the confirmation timestamp and the confirmation method identifier are included as data fields within the cryptographic attestation and are cryptographically bound thereto such that subsequent validation of the digital signature verifies the confirmation timestamp and the confirmation method identifier.

Clause 17: The method of any of clauses 1-16, wherein the receiving of the structured device dataset, the generating of the confirmed structured device dataset and the confirmed unified property metadata profile, the generating of the cryptographic attestation, and the storing of the confirmed unified property metadata profile and the cryptographic attestation define a first capture session associated with the unique property identifier, and wherein a subsequent capture session associated with the same unique property identifier includes subsequently receiving a subsequent structured device dataset associated with the one or more property-associated electronic devices located at the real estate property, generating a subsequent confirmed structured device dataset and a subsequent confirmed unified property metadata profile including the same unique property identifier, generating a subsequent cryptographic attestation for the subsequent confirmed unified property metadata profile, and storing the subsequent confirmed unified property metadata profile and the subsequent cryptographic attestation, wherein the subsequent cryptographic attestation includes a reference to, or a cryptographic hash of, the cryptographic attestation, such that the subsequent cryptographic attestation is cryptographically linked to the cryptographic attestation and the cryptographic attestation and the subsequent cryptographic attestation form a verifiable lifecycle record associated with the unique property identifier across ownership transfers of the real estate property.

Clause 18: The method of any of clauses 1-17, wherein a capture session associated with the structured device dataset comprises a first authorization stage in which a property participant grants network access to a hardware scanner node thereby enabling RF-based detection of wireless signal emissions, and a second authorization stage in which the property participant confirms the structured device dataset prior to generation of the cryptographic attestation.

Clause 19: A system for generating a cryptographically verifiable property-associated electronic device metadata record for a real estate property, comprising: at least one processor configured to: receive a structured device dataset including device metadata associated with one or more property-associated electronic devices located at the real estate property; identify or retrieve a unique property identifier for the real estate property; generate a unified property metadata profile including the unique property identifier and the structured device dataset; provide the unified property metadata profile to at least one user device; receive, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof; generate, based on the user input, a confirmed structured device dataset and a confirmed unified property metadata profile including the confirmed structured device dataset and the unique property identifier; generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value; generate a digital signature over the cryptographic binding value for the confirmed unified property metadata profile using a private cryptographic key to produce a cryptographic attestation that binds the confirmed structured device dataset to the unique property identifier; and store the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

Clause 20: The system of clause 19, further comprising: a hardware scanner node deployed at the real estate property, the hardware scanner node including at least one wireless communication interface configured to receive wireless signal emissions within a reception range of the at least one wireless communication interface, wherein the hardware scanner node is configured to: scan, using the at least one wireless communication interface, for wireless signal emissions associated with one or more property-associated electronic devices located at the real estate property; detect the one or more property-associated electronic devices based on the received wireless signal emissions; extract, from the received wireless signal emissions, device metadata associated with the one or more property-associated electronic devices; generate the structured device dataset including the device metadata associated with the one or more property-associated electronic devices; and provide the structured device dataset to the at least one processor.

Clause 21: A computer program product comprising at least one non-transitory computer-readable medium including program instructions for generating a cryptographically verifiable property-associated electronic device metadata record for a real estate property that, when executed by at least one processor, cause the at least one processor to: receive a structured device dataset including device metadata associated with one or more property-associated electronic devices located at the real estate property; identify or retrieve a unique property identifier for the real estate property; generate a unified property metadata profile including the unique property identifier and the structured device dataset; provide the unified property metadata profile to at least one user device; receive, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof; generate, based on the user input, a confirmed structured device dataset and a confirmed unified property metadata profile including the confirmed structured device dataset and the unique property identifier; generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value; generate a digital signature over the cryptographic binding value for the confirmed unified property metadata profile using a private cryptographic key to produce a cryptographic attestation that binds the confirmed structured device dataset to the unique property identifier; and store the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for generating a cryptographically verifiable property-associated electronic device metadata record for a real estate property, according to some non-limiting embodiments or aspects;

FIG. 2 is a schematic diagram of example components of one or more devices of FIG. 1, according to some non-limiting embodiments or aspects;

FIGS. 3A-3C are flow diagrams of a method for generating a cryptographically verifiable property-associated electronic device metadata record for a real estate property, according to some non-limiting embodiments or aspects;

FIG. 4 is a signal flow diagram of example scanning performed over a plurality of discovery cycles within a defined verification window to generate a candidate device list and a confirmed device list, according to some non-limiting embodiments or aspects; and

FIG. 5 is a table of example registry-contract evidentiary records for a pre-instantiated property identity infrastructure, including region-specific blockchain anchoring records, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “the device,” “a server,” “the server,” “a processor,” “the processor,” “a computing device,” “the computing device,” and/or the like, as used herein, may refer to a previously-recited device, server, processor, or computing device that is recited as performing a previous step or function, a different device, server, processor, or computing device, and/or a combination of devices, servers, processors, and/or computing devices. For example, as used in the specification and the claims, a first device, a first server, a first processor, or a first computing device that is recited as performing a first step or a first function may refer to the same or different device, server, processor, or computing device recited as performing a second step or a second function.

As used herein, the term “real estate property” may refer to any parcel, lot, tract, or other legally or practically identifiable physical location, together with any buildings, structures, fixtures, or improvements situated thereon, that is capable of being identified by one or more location descriptors (e.g., a street address, unit designation, parcel identifier, geospatial coordinates, jurisdictional descriptors, or combinations thereof). In some non-limiting embodiments or aspects, a real estate property may include a single-family residence, a multi-family dwelling, a condominium unit, a townhouse, an apartment unit, a manufactured or mobile home site, a commercial building, an industrial facility, a mixed-use property, a short-term rental property, or a portion of a larger property (e.g., a unit, suite, floor, or designated area) that is associated with a distinct occupancy, ownership, or access-control boundary. A real estate property may further include associated outdoor areas (e.g., yards, garages, outbuildings, patios) and may encompass one or more zones in which property-associated electronic devices are installed, mounted, integrated, or otherwise physically associated with the property.

As used herein, the term “property-associated electronic device” may refer to any electronic device that is installed, mounted, integrated, affixed, configured, located, or otherwise physically associated with a real estate property (or a defined portion thereof) such that the device is intended to remain with, serve, or operate in relation to the real estate property rather than being a transient personal mobile device of an occupant. In some non-limiting embodiments or aspects, a property-associated electronic device may include a monitoring, control, automation, safety, security, energy-management, access-control, appliance, sensor, or other electronic system that emits, broadcasts, advertises, responds to, or otherwise produces locally receivable wireless signal emissions (e.g., wireless advertisements, beacons, management frames, service announcements, or other protocol data units (PDUs)) that can be detected by a receiver device while deployed at the real estate property. By way of example and without limitation, property-associated electronic devices may include security cameras, video doorbells, smart locks, access control readers, garage door controllers, alarm panels, window/door sensors, motion sensors, glass-break sensors, smoke detectors, carbon monoxide detectors, water leak sensors, environmental sensors, thermostats, HVAC controllers, lighting controllers, irrigation controllers, energy monitors, network gateways, wireless access points, smart speakers, smart displays, smart appliances (e.g., refrigerators, ovens, microwaves, dishwashers, etc.), and/or similar electronic fixtures or systems, whether communicating via short-range wireless protocols and/or local network interfaces. A property-associated electronic device may be “associated” with the real estate property even if the device is temporarily offline, intermittently present, or not actively connected to an IP network, provided that the device remains physically associated with the real estate property and is capable of producing one or more externally observable emissions or identifiers usable for detection and metadata extraction as described herein.

As used herein, the term “wireless signal emissions” may refer to any externally observable, locally receivable wireless and/or local-network signaling produced, transmitted, broadcast, advertised, responded to, or otherwise emitted by an electronic device (or by a network component associated with such device) that is capable of being received by a receiver device. In some non-limiting embodiments or aspects, wireless signal emissions may include one or more of: radio-frequency (RF) transmissions; short-range wireless advertisements; periodic beacons; discovery beacons; management frames; control frames; service announcements; device discovery packets; pairing or association packets; and/or other PDUs that may contain device identifiers, service identifiers, manufacturer data, capability indicators, or other externally observable metadata. By way of example and without limitation, wireless signal emissions may include: IEEE 802.11 (Wi-Fi®) beacon frames, probe requests, probe responses, association requests/responses, authentication frames, and/or other Wi-Fi management or discovery traffic; Bluetooth and/or Bluetooth Low Energy (BLE) advertising packets (including service UUID advertisements, manufacturer-specific data fields, and/or other advertisement payloads); IEEE 802.15.4-based emissions including Zigbee discovery/join traffic, Thread discovery traffic, and/or Matter-related discovery advertisements; Z-Wave discovery and/or inclusion traffic; Near Field Communication (NFC) emissions; ultra-wideband (UWB) signaling; infrared (IR) signaling; and/or other locally receivable wireless discovery traffic or broadcast emissions. In some non-limiting embodiments or aspects, wireless signal emissions may further include locally receivable signaling associated with one or more wireless and/or local network communication technologies, including without limitation local cellular radios (e.g., LTE/5G) used for device backhaul, Ethernet (IEEE 802.3), powerline networking, and/or other short-range wireless and/or local network communication technologies, to the extent such signaling is externally observable and usable for device detection and/or metadata extraction. In some non-limiting embodiments or aspects, wireless signal emissions may further include locally receivable emissions produced by property networking equipment associated with the property (e.g., access points, gateways, hubs, bridges, repeaters, controllers, and/or mesh networking components) to the extent such emissions are associated with discovery, presence, or operation of one or more property-associated electronic devices.

As used herein, the term “structured device dataset” may refer to a machine-readable, structured representation of device-related information associated with one or more property-associated electronic devices, the structured representation being organized according to a defined schema such that the information may be stored, transmitted, parsed, indexed, and/or processed by one or more computing devices. In some non-limiting embodiments or aspects, a structured device dataset may include a set of device records (e.g., one record per detected or candidate device), and each device record may include one or more device metadata fields derived from locally receivable wireless signal emissions and/or supplemental device metadata captured as described herein. In some non-limiting embodiments or aspects, a structured device dataset may be encoded using one or more structured data formats (e.g., JSON, XML, CBOR, protocol buffers, and/or other structured encodings) and may include, in addition to device metadata, one or more contextual fields such as timestamps, verification window identifiers, discovery-cycle identifiers, interface identifiers, signal strength values, and/or other reception context usable to support subsequent processing, verification, and/or downstream integration.

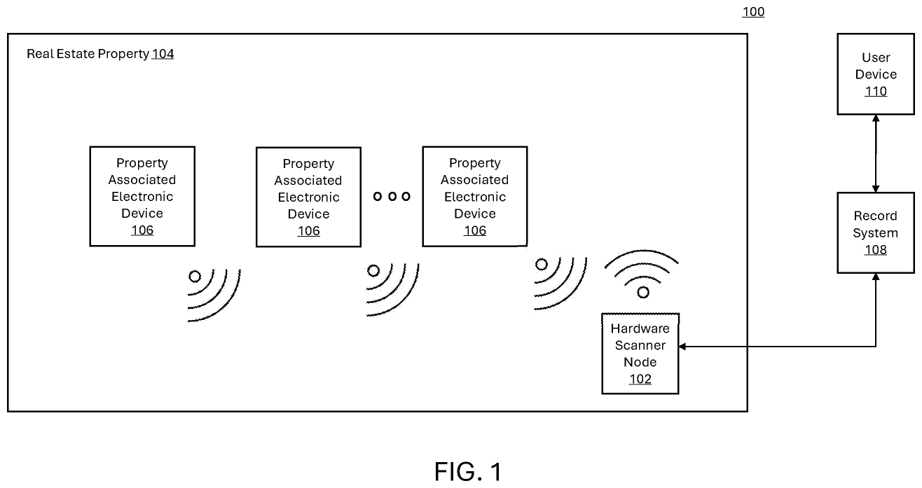

Referring now to FIG. 1, shown is system 100 for generating a cryptographically verifiable property-associated electronic device metadata record for a real estate property, according to some non-limiting embodiments or aspects. System 100 may include hardware scanner node 102, which may be deployed at real estate property 104 that includes one or more property-associated electronic devices 106, such as a plurality of property-associated electronic devices 106 and/or record system 108. System 100 may enable generation of a cryptographically verifiable property-associated electronic device metadata record for real estate property 104.

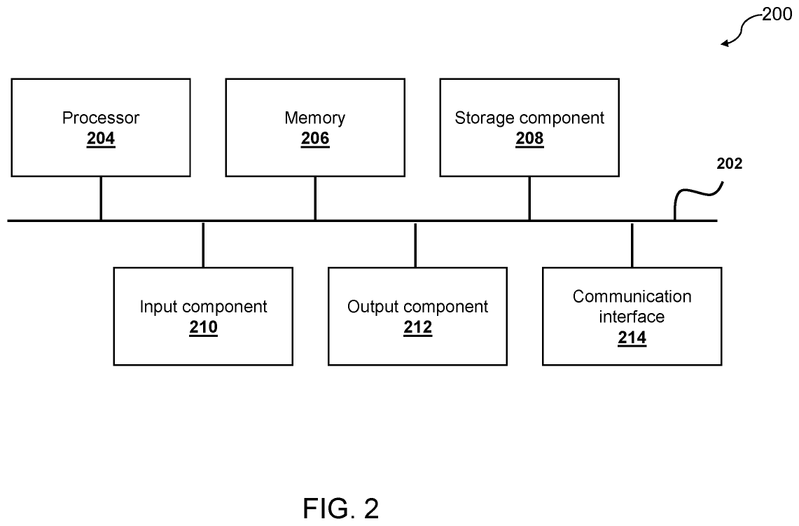

Hardware scanner node 102 may include at least one computing device, as described herein. For example, hardware scanner node 102 may include at least one device 200 (see, e.g., FIG. 2), including one or more of bus 202, processor 204, memory 206, storage component 208, input component 210, output component 212, and/or communication interface 214. Communication interface 214 may include a transceiver-like component (e.g., a transceiver, separate receiver and transmitter, and/or the like) that enables hardware scanner node 102 to receive wireless signal emissions and/or communicate with other devices via one or more wired and/or wireless connections (e.g., via a radio frequency (RF) interface, IEEE 802.11 (Wi-Fi®) interface, Bluetooth and/or Bluetooth Low Energy (BLE) interface, IEEE 802.15.4 interface, Zigbee interface, Thread interface, Matter interface, Z-Wave interface, Near Field Communication (NFC) interface, ultra-wideband (UWB) interface, infrared (IR) interface, cellular interface (e.g., LTE/5G) for backhaul, Ethernet (IEEE 802.3) interface, powerline networking interface, and/or other short-range wireless and/or local network communication interfaces capable of receiving or exchanging locally observable emissions, advertisements, beacons, management frames, service announcements, and/or other PDUs).

In some non-limiting embodiments or aspects, hardware scanner node 102 may be implemented as a multi-modal sensor array device further including, in addition to the at least one wireless communication interface, at least one audio capture component and/or at least one optical capture component. For example, the at least one audio capture component may include one or more microphones and associated audio sampling circuitry configured to capture raw audio data at real estate property 104, and the at least one optical capture component may include one or more image sensors, cameras, infrared imaging components, depth sensors, and/or other optical sensing components configured to capture raw optical data associated with real estate property 104 and/or one or more property-associated electronic devices 106. In some implementations, hardware scanner node 102 may provide raw audio data, raw RF signal data, raw optical data, and/or observation context associated therewith to record system 108, while hardware scanner node 102 remains a capture-layer device that does not perform property-address normalization, property identity resolution, device fingerprint matching, path determination, and/or dataset assembly.

In some non-limiting embodiments or aspects, the at least one wireless communication interface of hardware scanner node 102 may include and/or be implemented by communication interface 214, and processor 204 may execute instructions stored in memory 206 and/or storage component 208 to cause hardware scanner node 102 to perform one or more operations described herein, including scanning for locally receivable wireless signal emissions, detecting one or more property-associated electronic devices 106, parsing one or more PDUs, extracting device metadata, and generating a structured device dataset. Storage component 208 may store scan results and/or structured device datasets (e.g., for buffering when connectivity is intermittent), and communication interface 214 may provide the structured device dataset (and, in some embodiments, scanner attestation data) to record system 108, as described herein.

In some non-limiting embodiments or aspects, the at least one wireless communication interface may be implemented using receiver circuitry, transceiver circuitry, and/or multiple radio front ends, and may include one or more antennas and associated signal processing components. In such embodiments, a wireless communication interface may be configured for receive-only operation (e.g., passive monitoring of advertisements and beacons), transmit-only operation (e.g., selective solicitation), or transceiver operation (e.g., supporting active scanning). In some non-limiting embodiments or aspects, a plurality of wireless communication interfaces may be implemented as separate radios and/or as separate logical interfaces supported by a common radio subsystem, and the interface identifier associated with a received emission may be stored as part of observation context to support later correlation and confirmation. In this way, implementing a plurality of wireless communication interfaces as separate radios and/or separate logical interfaces and storing interface identifiers as observation context enables improved device-detection coverage across protocol families and frequency bands and reduces false positives by supporting cross-interface corroboration and de-duplication during confirmation, as described herein.

In some non-limiting embodiments or aspects, hardware scanner node 102 may include a plurality of wireless communication interfaces, and different wireless communication interfaces may be implemented using different instances of communication interface 214 and/or different RF interfaces supported thereby, such that hardware scanner node 102 may receive different types of wireless signal emissions (e.g., emissions associated with different protocol families and/or frequency bands) from different property-associated electronic devices 106 located at real estate property 104 and/or different communication wireless communication interfaces of a same property-associated electronic device 106 located at real-estate property 104. Additionally or alternatively, output component 212 may include one or more indicators (e.g., LEDs) to indicate operational status, and input component 210 may include one or more controls (e.g., a reset button, an initiate scanning button, etc.) to support deployment and provisioning at real estate property 104.

In some non-limiting embodiments or aspects, a reception range of the at least one wireless communication interface may vary based on environmental conditions at real estate property 104 and characteristics of the wireless communication interface. For example, reception range may be affected by placement of hardware scanner node 102 within the property, building materials (e.g., walls, floors, insulation, metal objects), interference sources, antenna orientation, and the frequency band and modulation scheme used by a given device. In some non-limiting embodiments or aspects, where hardware scanner node 102 includes multiple wireless communication interfaces, the reception range may differ among the interfaces (e.g., a first interface may receive a first class of emissions over a first range and a second interface may receive a second class of emissions over a different range), and scanning operations may account for such differences when aggregating observations across discovery cycles, as described herein.

The one or more property-associated electronic devices 106 may be disposed at, within, or in association with real estate property 104 and may be detectable by hardware scanner node 102, while deployed at real estate property 104. In some non-limiting embodiments or aspects, hardware scanner node 102 may detect property-associated electronic devices 106 by receiving one or more wireless signal emissions and/or other externally observable signaling associated with property-associated electronic devices 106 (including, in some embodiments, signaling emitted by property networking equipment that is associated with the discovery, presence, or operation of such devices). In some non-limiting embodiments or aspects, property-associated electronic devices 106 may be detectable based on broadcast advertisements or other externally observable emissions even when not actively connected to an IP network, and property-associated electronic devices 106 may be intermittently present and/or temporarily offline, while remaining physically associated with real estate property 104.

Record system 108 may include at least one computing device, as described herein. For example, record system 108 may include one or more devices 200 (see, e.g., FIG. 2), including one or more of bus 202, processor 204, memory 206, storage component 208, input component 210, output component 212, and/or communication interface 214. In some non-limiting embodiments or aspects, record system 108 may be implemented using one or more server computers, cloud computing resources, distributed computing nodes, and/or other computing devices (including one or more virtual machines, containers, and/or microservices), wherein one or more processors 204 of such devices 200 collectively correspond to at least one processor distinct from hardware scanner node 102. Communication interface 214 may include a transceiver-like component (e.g., a transceiver, separate receiver and transmitter, and/or the like) that enables record system 108 to communicate with hardware scanner node 102 and/or other external systems via one or more wired and/or wireless connections, and storage component 208 may store data associated with the operations described herein (e.g., device datasets, property identifiers, metadata profiles, and cryptographic artifacts).

In some non-limiting embodiments or aspects, systems and methods described herein may be implemented as an interdependent architecture in which (i) hardware scanner node 102 provides a physical on-site acquisition component that captures locally receivable device metadata from property-associated electronic devices 106, (ii) record system 108 provides a processing and verification component that classifies, enriches, and audits the captured device metadata to generate machine-readable audit and verification artifacts, and (iii) one or more lifecycle processes (e.g., audit, wipe, and handoff) provide compliance-oriented outputs that are bound to a unique property identifier and are independently verifiable. In some non-limiting embodiments or aspects, certain processes, operations, and/or functions are described herein as being performed by hardware scanner node 102 and other processes, operations, and/or functions are described as being performed by record system 108 (and/or by at least one processor distinct from hardware scanner node 102) for purposes of explanation and clarity. However, non-limiting embodiments or aspects are not limited thereto and, in some non-limiting embodiments or aspects, any one or more of the processes, operations, and/or functions described herein as being performed by record system 108 may, additionally or alternatively, be performed by hardware scanner node 102, including embodiments in which such processes, operations, and/or functions are performed solely by hardware scanner node 102 (e.g., locally at the real estate property) and/or in which processing is distributed between hardware scanner node 102 and record system 108 in any combination. In some non-limiting embodiments or aspects, functional blocks and process steps may be rearranged, consolidated, decomposed, and/or implemented using different computing architectures, provided that the resulting implementation performs operations described herein.

User device 110 may include at least one computing device, as described herein. For example, user device 110 may include at least one device 200 (see, e.g., FIG. 2), including one or more of bus 202, processor 204, memory 206, storage component 208, input component 210, output component 212, and/or communication interface 214. In some non-limiting embodiments or aspects, user device 110 may be implemented as a mobile device, such as a smartphone, tablet computer, portable computing device, and/or other handheld or wearable computing device, although desktop computers, laptop computers, and/or other computing devices may, additionally or alternatively, be used. Communication interface 214 may include a transceiver-like component (e.g., a transceiver, separate receiver and transmitter, and/or the like) that enables user device 110 to communicate with record system 108, hardware scanner node 102, and/or one or more external systems via one or more wired and/or wireless connections. In some non-limiting embodiments or aspects, user device 110 may execute a mobile application, browser-based interface, and/or other client-side software to present one or more interfaces associated with a capture session for real estate property 104, including a device intake interface, a review interface, and/or a confirmation interface. Input component 210 may receive one or more user inputs associated with initiating scanning, accessing a portal, accessing a secure session link, scanning a session QR code, confirming one or more property-associated electronic devices 106, requesting removal of one or more property-associated electronic devices 106, requesting addition of one or more property-associated electronic devices 106, providing supplemental device metadata, capturing photographic input, receiving voice input, and/or entering manual text input. Output component 212 may provide one or more visual, audible, and/or tactile outputs associated with session status, candidate device information, unified property metadata profile information, confirmation prompts, and/or other workflow outputs described herein. Processor 204 may execute instructions stored in memory 206 and/or storage component 208 to cause user device 110 to receive data from record system 108, provide user inputs to record system 108, and/or facilitate one or more review, confirmation, supplementation, and/or authorization operations associated with generating the property-associated electronic device record for real estate property 104.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

Referring now to FIG. 2, shown is a diagram of example components of device 200, according to non-limiting embodiments. Device 200 may correspond to hardware scanner node 102, one or more property-associated electronic devices 106, and/or record system 108, as an example. In some non-limiting embodiments or aspects, such systems or devices may include at least one device 200 and/or at least one component of device 200. The number and arrangement of components shown are provided as an example. In some non-limiting embodiments or aspects, device 200 may include additional components, fewer components, different components, or differently arranged components than those shown. Additionally or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

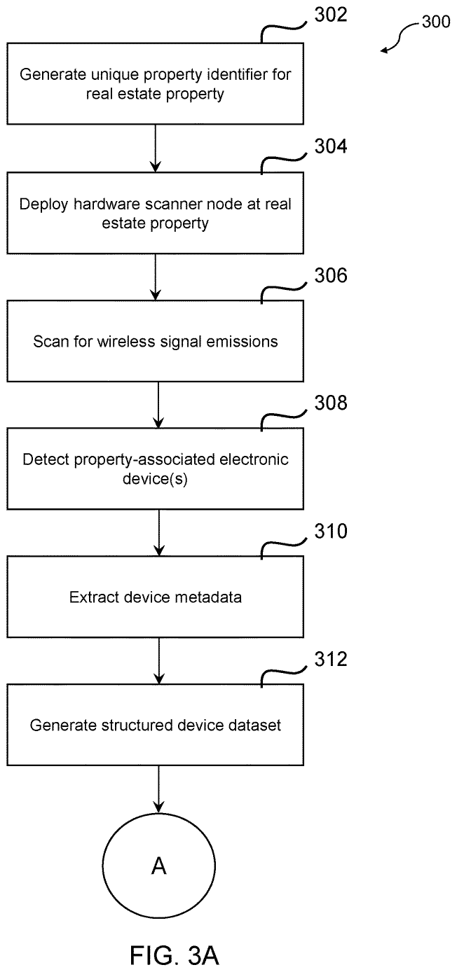

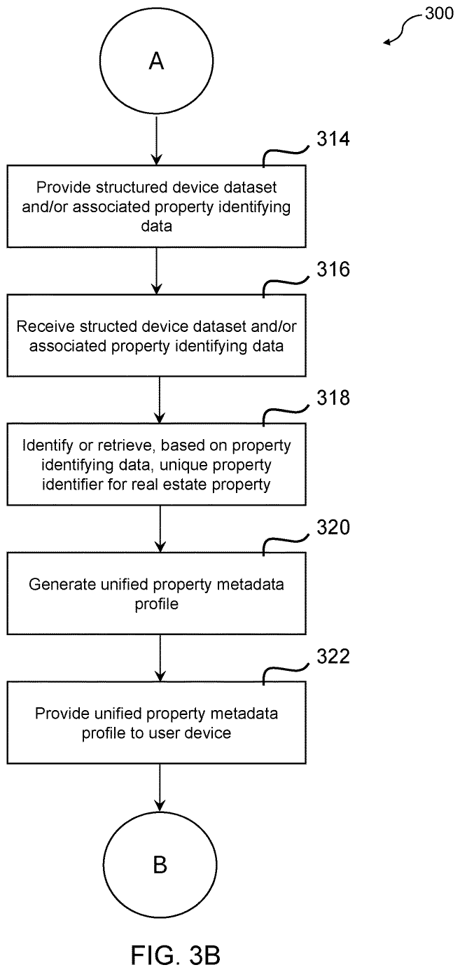

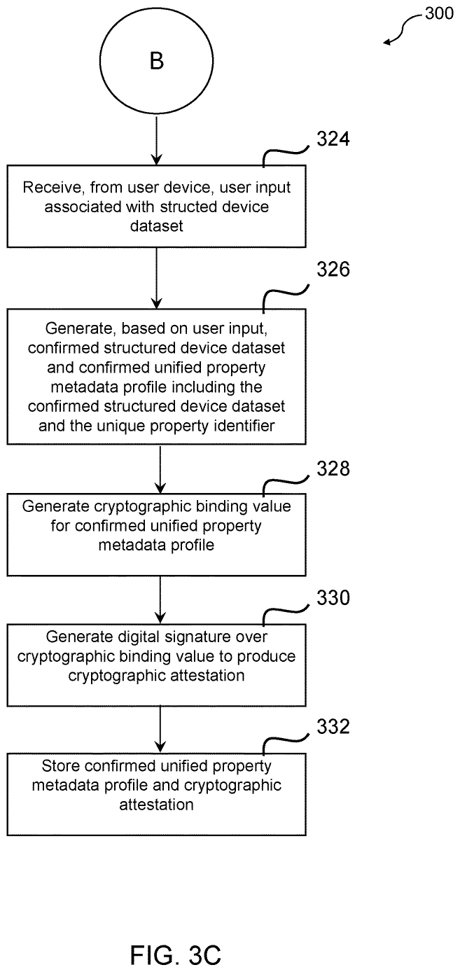

Referring now to FIGS. 3A-3C, shown are flow diagrams for a method for generating a cryptographically verifiable property-associated electronic device metadata record for a real estate property, according to some non-limiting embodiments or aspects. The steps shown in FIGS. 3A-3C are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 3A, at step 302, process 300 may include: generating a unique property identifier for a real estate property. For example, record system 108 may generate a unique property identifier for real estate property 104. As an example, record system 108 may generate the property identifier for real estate property 104 by: obtaining property address data associated with real estate property 104; applying a salting operation to the property address data to generate salted property address data; and processing the salted property address data using a deterministic key generation algorithm to produce the unique property identifier. In such an example, the salting operation may include combining the property address data with a salt value and/or applying one or more transformations to reduce ambiguity, deter reversal of the property address data, and/or reduce collisions between identifiers generated for different real estate properties. In some non-limiting embodiments or aspects, the salting operation may include concatenating or otherwise combining canonicalized property address data with a salt value in a defined ordering prior to processing and/or applying the salt value through a keyed transformation.

In some non-limiting embodiments or aspects, the unique property identifier for real estate property 104 is generated before hardware scanner node 102 is deployed at real estate property 104. For example, the unique property identifier may be generated or exist independently of and prior to hardware scanner node 102 and/or another device, such as user device 110, obtaining (e.g., scanning, capturing, detecting, etc.) data or metadata, while deployed or located at real estate property 104. In this way, use of a pre-existing unique property identifier for real estate property 104 may improve technical operation of later capture, matching, and attestation workflows by providing a persistent property-binding reference that is independent of transient deployment state, onboarding state, and/or later device-configuration events at real estate property 104. Accordingly, record system 108 may reduce ambiguity in associating captured device observations with real estate property 104 and may perform subsequent confirmation, attestation, storage, and verification operations against a stable property identity layer rather than a property identity created during a later configuration process.

In some non-limiting embodiments or aspects, systems and methods described herein may not be directed to configuring a building automation system or to creating a property identity during installation, commissioning, deployment, onboarding, or provisioning of one or more property-associated electronic devices 106 and/or hardware scanner node 102 at real estate property 104. Rather, the unique property identifier associated with real estate property 104 may be generated before such installation, commissioning, deployment, onboarding, or provisioning activity occurs, and/or may be retrieved from a pre-instantiated property identity infrastructure in which the unique property identifier already exists independently of and prior to any such activity. In this manner, later device-discovery, metadata-capture, confirmation, attestation, and/or provisioning-related operations may be associated with a pre-existing property identity layer for real estate property 104 rather than being used to create the property identity layer.

In some non-limiting embodiments or aspects, generating the unique property identifier for real estate property 104 includes generating a plurality of unique property identifiers for a plurality of real estate properties. For example, record system 108 may generate the plurality of unique property identifiers for the plurality of real estate properties by: obtaining, for each real estate property of the plurality of real estate properties, corresponding property address data associated with that real estate property; applying, for each real estate property of the plurality of real estate properties, the salting operation to the corresponding property address data associated with that real estate property to generate corresponding salted property address data for that real estate property;

processing, for each real estate property of the plurality of real estate properties, the corresponding salted property address data for that real estate property using the deterministic key generation algorithm to produce a corresponding unique property identifier for that real estate property; and storing, in a data repository or a database, the plurality of unique property identifiers for the plurality of real estate properties, wherein the corresponding unique property identifier for each real estate property is stored in association with the corresponding property address data associated with that real estate property.

In some non-limiting embodiments or aspects, the plurality of unique property identifiers generated for the plurality of real estate properties may be pre-instantiated as a property identity infrastructure before initiation of a capture session for a given real estate property or any of the plurality of real-estate properties and before deployment of hardware scanner node 102 at the given real estate property or any of the plurality of real estate properties. For example, record system 108 may generate and store (e.g., in one or more data repositories or databases, etc.) a plurality of unique property identifiers for a large population of residential real estate properties in advance of any property-specific scanning workflow, such that the unique property identifier for a given real estate property exists independently of later device-discovery, metadata-capture, confirmation, and attestation operations. In some examples, the property identity infrastructure may include a national-scale registry of residential real estate properties. In this manner, the property identity infrastructure may provide a pre-existing identity layer to which later-generated structured device datasets, unified property metadata profiles, and cryptographic attestations are associated.

In some implementations, pre-instantiating the property identity infrastructure may include storing source data for the plurality of residential real estate properties in one or more data repositories and deriving cryptographic commitments from the stored source data. For example, the source data may include address data for the plurality of residential real estate properties stored in cloud object storage, although any suitable storage repository may be used. In some examples, record system 108 may partition the plurality of unique property identifiers, and/or data associated therewith, into a plurality of regional datasets and may generate a respective Merkle root for each regional dataset. Each Merkle root may provide a cryptographic commitment to the underlying dataset, such that a change in the underlying dataset causes a corresponding change in the Merkle root.

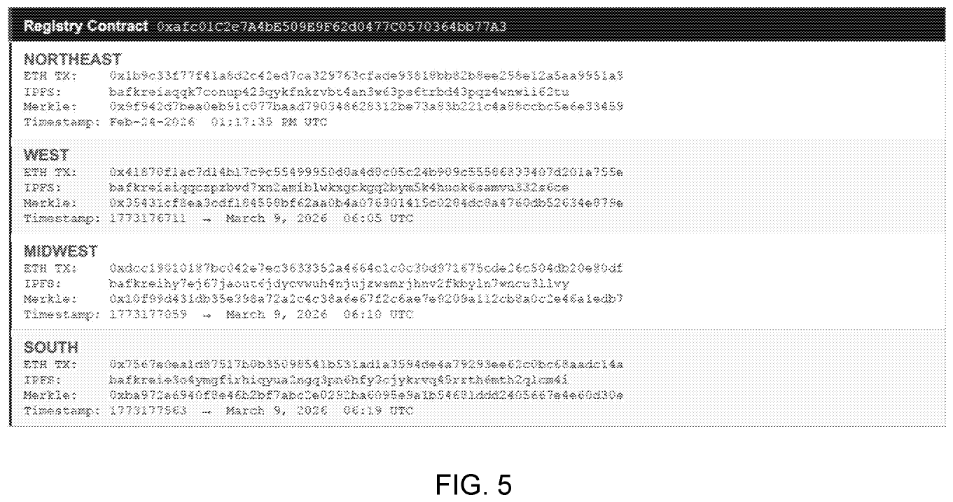

In some implementations, the pre-instantiated property identity infrastructure may further include a registry contract associated with a plurality of region-specific records for the plurality of unique property identifiers. For example, as shown in FIG. 5, the registry contract may be associated with a plurality of regional datasets, such as Northeast, West, Midwest, and South datasets, each regional dataset being represented by a corresponding blockchain transaction identifier, a corresponding content-addressed storage identifier, a corresponding Merkle root, and a corresponding timestamp. In such an example, data corresponding to the regional datasets and/or the respective Merkle roots may be pinned to a content-addressed distributed file system, such as InterPlanetary File System (IPFS), to generate corresponding content identifiers, and the corresponding content identifiers may be anchored to a blockchain, such as the Ethereum blockchain, using corresponding blockchain transactions. The registry contract and the region-specific records may thereby provide a cryptographically verifiable record of the pre-instantiated property identity infrastructure, whereby the plurality of unique property identifiers are committed in a tamper-evident manner and may be independently verified. In some implementations, independent verification of pre-existence of a given unique property identifier may include obtaining, by a verifier, the region-specific record corresponding to a regional dataset that includes the given unique property identifier, obtaining the corresponding blockchain transaction identifier, content-addressed storage identifier, Merkle root, and timestamp for that regional dataset, retrieving the corresponding region-specific dataset content from the content-addressed distributed file system, and verifying that the Merkle root and the blockchain-anchored record correspond to the retrieved region-specific dataset content. The verifier may then determine whether the given unique property identifier is represented in the verified region-specific dataset and may thereby confirm that the given unique property identifier existed as part of the pre-instantiated property identity infrastructure before a later capture session associated with the real estate property.

In some implementations, the pre-instantiated property identity infrastructure may be established, according to an evidentiary chain, in which source data for a plurality of residential real estate properties is stored in a repository, one or more regional datasets are derived from the source data, a respective Merkle root is generated for each regional dataset, data corresponding to the regional datasets and/or the respective Merkle roots is pinned to a content-addressed distributed file system to generate corresponding content identifiers, and the corresponding content identifiers are anchored to a blockchain to create a time-verifiable cryptographic record. For example, the source data may include a plurality of residential addresses, the repository may include cloud object storage, the content-addressed distributed file system may include IPFS, and the blockchain may include Ethereum. These features may be used individually or in any combination to improve scalability of the property identity infrastructure, support efficient validation of large datasets, reduce data storage and network overhead, and enable reliable association of subsequently captured property-specific data with a pre-instantiated unique property identifier.

In some implementations, operation of record system 108 with respect to a given real estate property may follow a multi-path architecture. In a first example, when the given real estate property is already represented in the pre-instantiated property identity infrastructure, record system 108 may identify the given real estate property based on property-identifying data and may retrieve the corresponding unique property identifier from the pre-instantiated property identity infrastructure. In a second example, when the given real estate property is not represented in the pre-instantiated property identity infrastructure, record system 108 may generate a new unique property identifier for the given real estate property and may store the new unique property identifier, such that the new unique property identifier becomes part of the property identity infrastructure for subsequent use. In either example, the unique property identifier may be available independently of a later capture session and may be used to associate subsequently generated property-associated electronic device metadata with the given real estate property.

Property address data may include one or more address-related descriptors usable to identify a location of real estate property 104, including, by way of example and without limitation, a street address (e.g., street number and street name), unit designator (e.g., apartment, suite, floor, or lot number), municipality or locality, state or province, postal code, country code, and/or jurisdictional descriptors. In some non-limiting embodiments or aspects, property address data may further include structured identifiers associated with a property location, such as a parcel identifier, assessor's parcel number (APN), lot/block designation, building identifier, and/or other property registry identifiers, to the extent such identifiers are available and are treated as part of the property address data for identifier generation, as described herein.

In some non-limiting embodiments or aspects, property address data may be stored as a structured object comprising multiple fields (e.g., street number, street name, unit designator, locality, state/province, postal code, country code) rather than as an unstructured text string, thereby enabling deterministic normalization and hierarchical parsing operations described herein. In such embodiments, when one or more registry identifiers (e.g., parcel identifier, APN, lot/block) are available, such identifiers may be incorporated as part of the property address data object as optional fields.

In some non-limiting embodiments or aspects, the salt value used in the salting operation is stored and managed by record system 108 and is derived from one or more protected secrets. For example, record system 108 may maintain a platform secret (e.g., a master secret stored in a protected key store) and derive a per-property salt value from the platform secret using a deterministic derivation process that incorporates property-specific input (e.g., the unique property identifier and/or canonicalized property address data) and, optionally, a version identifier corresponding to a salt rotation policy. Additionally or alternatively, record system 108 may maintain a per-property secret value associated with a given real estate property of the plurality of real estate properties and derive the salt value from the per-property secret. Additionally or alternatively, record system 108 may derive a version-specific secret (e.g., based on a key-rotation epoch) and incorporate the version-specific secret into the salt value derivation. In such embodiments, the salt value may be reproducible for a given derivation configuration, while remaining resistant to reversal and enumeration, and record system 108 may store a salt version identifier or key identifier as associated metadata to enable deterministic regeneration of the salt value for later verification.

In some non-limiting embodiments or aspects, generating the unique property identifier further includes processing the salted property address data using a deterministic key generation algorithm to produce the unique property identifier. The deterministic key generation algorithm may be configured, such that the same property address data, when subjected to the same salting operation and algorithm parameters, yields a consistent unique property identifier, thereby enabling reproducible association between real estate property 104 and downstream property metadata artifacts. In some non-limiting embodiments or aspects, the deterministic key generation algorithm may include one or more cryptographic operations, including a cryptographic one-way function and/or a key derivation function (KDF). For example, processing the salted property address data using the deterministic key generation algorithm may include applying a cryptographic one-way function or a KDF to the salted property address data to produce the unique property identifier, and/or applying the salting operation may include combining the property address data with the salt value, the salt value being derived from at least one of a platform secret, a per-property secret, or a version-specific secret maintained by record system 108.

A cryptographic one-way function may include a function that deterministically maps an input value to an output value in a manner that is computationally infeasible to invert (i.e., derive the input from the output) and that is sensitive to input changes, such that small changes to the input produce different outputs. By way of example and without limitation, a cryptographic one-way function may include a cryptographic hash function that generates a fixed-length digest from input data (e.g., a SHA-256 hash of salted input data), such that the digest can be recomputed for verification but is not practically reversible to recover the original input.

A KDF may refer to a cryptographic function configured to derive one or more cryptographic keys or key-like outputs from input material (e.g., a secret, a passphrase, and/or other input data) using one or more strengthening operations (e.g., salting, iteration, and/or mixing), such that the derived output is suitable for use as an identifier, key, or binding value. By way of example and without limitation, a KDF may include a function that takes salted property address data (and optionally a secret) and produces a derived output of a specified length and format (e.g., a fixed-length identifier), such as an HMAC-based derivation, HKDF-based derivation, PBKDF2-based derivation, scrypt-based derivation, and/or Argon2-based derivation, although other KDF constructions may be used.

In some non-limiting embodiments or aspects, record system 108 may apply one or more pre-processing operations to the property address data prior to salting. For example, generating the unique property identifier may further include generating canonicalized property address data by normalizing the property address data, according to one or more normalization rules. The one or more normalization rules may reduce representational variance across address formats and may include abbreviation expansion, casing rules, punctuation rules, whitespace rules, standardization of unit designators, standardized jurisdiction codes, and/or combinations thereof.

In some non-limiting embodiments or aspects, generating the unique property identifier may further include obtaining geospatial location data associated with real estate property 104 (or the plurality of real estate properties) and/or generating normalized geospatial location data by converting the geospatial location data to a predetermined precision. For example, the geospatial location data may be obtained from one or more external sources, including a geocoding service, a property registry system, and/or one or more other location data sources. As an example, the predetermined precision may be implemented by rounding, truncating, quantizing, and/or otherwise converting coordinates to a fixed-precision representation prior to incorporation into salted input data, thereby improving determinism where raw coordinate sources exhibit minor variance.

In some non-limiting embodiments or aspects, applying the salting operation may include applying the salting operation to a combination of the canonicalized property address data and the normalized geospatial location data to generate the salted property address data. Record system 108 may concatenate, serialize, and/or otherwise combine the canonicalized property address data and the normalized geospatial location data in a defined ordering prior to combining with a salt value and/or applying a deterministic key generation algorithm. Use of the canonicalized property address data together with the normalized geospatial location data may improve robustness and reduce collisions by causing different salted property address data to be generated where either the canonicalized property address data or the normalized geospatial location data differs.

In some non-limiting embodiments or aspects, generating the canonicalized property address data may include parsing the property address data into a plurality of hierarchical location components and arranging the plurality of hierarchical location components in a predetermined hierarchical order to generate a hierarchical location encoding. The plurality of hierarchical location components may correspond to progressively finer-grained jurisdictional and/or location descriptors and may include one or more of a country code, a state or province identifier, a county identifier, a municipality or locality identifier, a postal code, a street name identifier, a street number identifier, and a unit designator. The county identifier may include a county name and/or a standardized code, such as a FIPS code. The unit designator may include an apartment, a suite, a lot, and/or another unit identifier. Record system 108 may normalize each hierarchical location component by applying canonical casing, abbreviation expansion, whitespace rules, punctuation rules, standardized code mappings, and/or combinations thereof, and may discard unavailable and/or non-applicable components for a given real estate property.

In some non-limiting embodiments or aspects, the predetermined hierarchical order may be selected to provide deterministic reproduction and reduce ambiguity across different representations of the same address. The predetermined hierarchical order may correspond to a jurisdiction-to-unit ordering including country, state/province, county, locality, postal code, street name, street number, and unit. The hierarchical location encoding may be represented as a delimited string, a fixed-field structure, a serialized object, and/or another machine-readable encoding. The hierarchical location encoding may include explicit field labels and/or length delimiters to reduce parsing ambiguity. Record system 108 may apply a canonical serialization rule to the hierarchical location encoding, including consistent delimiter selection, consistent field ordering, consistent empty-field handling, and/or combinations thereof, such that the hierarchical location encoding is reproducible across different computing environments.

In some non-limiting embodiments or aspects, applying the salting operation may include applying the salting operation to a combination of the hierarchical location encoding and the normalized geospatial location data to generate the salted property address data. Record system 108 may concatenate the hierarchical location encoding with the normalized geospatial location data in a defined ordering prior to combining with a salt value and/or applying a deterministic key generation algorithm. The normalized geospatial location data may include coordinates converted to the predetermined precision. The combined input may be constructed, such that changes to either the hierarchical location encoding or the normalized geospatial location data result in a different salted input, thereby increasing collision resistance and enabling the unique property identifier to reflect both jurisdictional/address hierarchy and physical location characteristics. Record system 108 may store the hierarchical location encoding and/or one or more intermediate normalized components as part of internal processing state for debugging, reconciliation, and/or audit purposes, while using the salted property address data and the unique property identifier for downstream binding and verification operations, as described herein.

As shown in FIG. 3A, at step 304, process 300 may include: deploying a hardware scanner node at a real estate property. For example, hardware scanner node 102 may be deployed at real estate property 104. As an example, hardware scanner node 102 may include at least one wireless communication interface configured to receive wireless signal emissions within a reception range of the at least one wireless communication interface. In such an example, deploying hardware scanner node 102 may include physically positioning hardware scanner node 102 within real estate property 104, such that at least one wireless communication interface of hardware scanner node 102 is capable of receiving wireless signal emissions within a reception range of the at least one wireless communication interface. The reception range may refer to a physical area in which the at least one wireless communication interface (e.g., implemented by communication interface 214 of device 200, as described with respect to FIG. 2) is capable of receiving locally receivable emissions (e.g., advertisements, beacons, management frames, service announcements, and/or other PDUs) produced by one or more property-associated electronic devices 106 located at real estate property 104 (and/or in proximity thereto). In some non-limiting embodiments or aspects, deploying hardware scanner node 102 further includes selecting a placement location within real estate property 104 that improves reception of wireless signal emissions (e.g., a centralized location, a location near a primary ingress/egress corridor, a location near a network gateway, and/or other locations expected to provide coverage for multiple rooms and/or zones).

As shown in FIG. 3A, at step 306, process 300 may include: scanning for wireless signal emissions associated with one or more property-associated electronic devices located at a real estate property. For example, hardware scanner node 102 may scan, using the at least one wireless communication interface, for wireless signal emissions associated with one or more property-associated electronic devices 106 located at real estate property 104. In some non-limiting embodiments or aspects, scanning, at step 306, may include passive scanning, in which hardware scanner node 102 listens for wireless signal emissions without initiating a connection to a device and may optionally include active scanning, in which hardware scanner node 102 transmits one or more discovery queries or solicitation messages intended to elicit responsive emissions (e.g., probe-style discovery traffic) from nearby devices. In some non-limiting embodiments or aspects, scanning may include channel scanning and/or channel hopping across one or more frequency bands supported by the at least one wireless communication interface (e.g., sequentially scanning channels, selecting channels based on a schedule, and/or scanning channels based on previously observed emissions), and may include receiving and/or decoding one or more PDUs that may be emitted, broadcast, advertised, or otherwise produced by property-associated electronic devices 106.

In some non-limiting embodiments or aspects, scanning by hardware scanner node 102 may be initiated in response to a trigger event associated with establishment of an authorized capture session for real estate property 104. The trigger event may include a user input received via input component 210 of hardware scanner node 102, an input received via user device 110, a seller input, an agent input, QR-code activation, and/or another session-authorization mechanism. In some non-limiting embodiments or aspects, the trigger event may be associated with authorization by a property participant for operation of hardware scanner node 102 within real estate property 104, such that scanning and metadata capture occur only within a bounded capture session for real estate property 104 rather than as continuous monitoring of the property environment.

In some non-limiting embodiments or aspects, the trigger event may include activation of hardware scanner node 102 at real estate property 104. For example, after hardware scanner node 102 is deployed at real estate property 104, a listing agent and/or another authorized participant may activate hardware scanner node 102, including via input component 210. In some embodiments, input component 210 may include one or more controls, such as a reset button, an initiate scanning button, and/or one or more other controls to support deployment and provisioning at real estate property 104. In response to activation, hardware scanner node 102 may generate, provide, and/or display a session identifier associated with the capture session, such as a session QR code. User device 110 may scan the session QR code, and record system 108 may establish the capture session in response to the QR-code interaction. Establishment of the capture session may include associating the capture session with the unique property identifier for real estate property 104 and causing a device intake interface to be provided on user device 110.

In some non-limiting embodiments or aspects, the trigger event may include access to a portal, a confirmation link, a secure session link, and/or another network-accessible interface associated via the capture session. Authorization for operation of hardware scanner node 102 may be obtained, while the property participant is physically present at real estate property 104 and/or may be communicated through electronic or telecommunication channels associated with the capture session, hardware scanner node 102, record system 108, and/or user device 110. For example, authorization may be conveyed through interaction with a mobile device interface of user device 110, a secure session link, electronic messaging, a portal, and/or another communication mechanism capable of verifying participant consent for operation of the capture session at real estate property 104. In some non-limiting embodiments or aspects, access to such interface by a seller, listing agent, and/or another authorized participant may initiate the capture session, authorize operation of hardware scanner node 102, associate the capture session with the unique property identifier for real estate property 104, and/or cause presentation of the device intake interface through which supplemental device entries may be received.

In some non-limiting embodiments or aspects, once the trigger event has occurred and the authorized capture session has been established, hardware scanner node 102 may perform scanning during the capture session by receiving wireless signal emissions from one or more property-associated electronic devices 106 within reception range of the at least one wireless communication interface. In some implementations, hardware scanner node 102 may function only as a passive capture node during the capture session and may not perform system orchestration, property identity binding, or dataset finalization, which may instead be performed by record system 108.

In some non-limiting embodiments or aspects, hardware scanner node 102 may be implemented as a “dumb” sensor array and/or capture-layer device configured to receive locally observable wireless signal emissions, extract device metadata from the wireless signal emissions, and transmit raw sensor data, extracted device metadata, and/or a structured device dataset including the device metadata to record system 108. In some non-limiting embodiments or aspects, hardware scanner node 102 may perform capture-layer acquisition and dataset preparation for transmission without performing, at hardware scanner node 102, a property-address normalization operation, a property identity resolution operation to determine the unique property identifier associated with real estate property 104, a device fingerprint matching operation, dataset finalization, system orchestration, or any combination thereof.

For example, hardware scanner node 102 may provide raw observations, reception context, other captured sensor data, and/or the structured device dataset for downstream processing, while record system 108 may perform normalization of property-identifying data associated with real estate property 104, resolve the unique property identifier associated with real estate property 104 based on the property-identifying data, determine whether an authorized capture session has been established, perform device fingerprint matching on device metadata included in the structured device dataset received from hardware scanner node 102, and/or perform dataset assembly. In some non-limiting embodiments or aspects, record system 108 may provide to hardware scanner node 102 a session authorization confirmation associated with an authorized capture session for real estate property 104 after record system 108 has identified the real estate property 104 for the capture session, and hardware scanner node 102 may initiate and/or continue scanning for wireless signal emissions only after receiving the session authorization confirmation, such that scanning by hardware scanner node 102 is bounded to the authorized capture session (e.g., such that scanning by hardware scanner node 102 does not constitute continuous or periodic monitoring of the real estate property 104, etc.).

In some non-limiting embodiments or aspects, operation of hardware scanner node 102 during the authorized capture session may include a first authorization stage and a second authorization stage performed at different points in process 300. For example, the first authorization stage may include a property participant granting network access consent for hardware scanner node 102, such as by providing access credentials, approving association of hardware scanner node 102 with one or more local networking resources of real estate property 104, approving use of a network-accessible interface associated with the capture session, and/or otherwise authorizing communication by hardware scanner node 102 sufficient to enable RF-based detection of wireless signal emissions associated with one or more property-associated electronic devices 106. In some implementations, after raw audio data, raw RF signal data, raw optical data, and/or device metadata derived therefrom are provided by hardware scanner node 102, record system 108 may perform address normalization, property identity resolution, device fingerprint matching, path determination, and dataset assembly, and may determine whether RF-based detection is available and sufficient for a particular capture session. When RF-based detection is unavailable, incomplete, and/or insufficient, record system 108 may activate optical data capture as a primary or supplemental capture modality while hardware scanner node 102 continues to operate as a capture-layer device. In some non-limiting embodiments or aspects, the second authorization stage may include the participant confirmation event associated with the structured device dataset as described herein, such that the property participant confirms the structured device dataset prior to generation of the cryptographic attestation. In some implementations, path determination may include determining, by record system 108, one or more processing paths to be applied to captured data for the capture session based on one or more characteristics of the captured data, one or more capture-quality conditions, one or more detected device classes, and/or one or more available capture modalities. For example, record system 108 may determine whether device identification for a given property-associated electronic device 106 is to proceed using RF-derived observations, optical-derived observations, audio-derived observations, supplemental entries received through the device intake interface, and/or one or more combinations thereof, and may route the corresponding observations through one or more normalization, matching, supplementation, and dataset-assembly operations associated with the determined processing path. In this way, separating capture-layer acquisition at hardware scanner node 102 from normalization, property identity resolution, device fingerprint matching, and dataset assembly at record system 108 may improve operation of the overall system by reducing computational complexity and attack surface at the edge of real estate property 104 while permitting centralized and consistent processing of heterogeneous captured observations. In this manner, record system 108 may apply uniform normalization, matching, and dataset-construction logic across different hardware scanner node implementations and across different capture sessions, thereby improving reproducibility, consistency, and verifiability of structured device datasets associated with the unique property identifier.

In some non-limiting embodiments or aspects, record system 108 may determine that RF-based detection is unavailable, incomplete, and/or insufficient for a particular capture session based on one or more capture-quality conditions. For example, record system 108 may determine that RF-based detection is unavailable, incomplete, and/or insufficient when fewer than a threshold number of wireless signal emissions are detected during a capture interval, when detected wireless signal emissions fail to satisfy a confidence threshold for generation of the structured device dataset, when one or more expected classes of property-associated electronic devices 106 are not represented in RF-derived observations, when one or more wireless communication interfaces of hardware scanner node 102 are disabled or unable to access a local wireless environment of real estate property 104, and/or when RF-derived observations fail to satisfy one or more completeness criteria for the capture session. In response to such a determination, record system 108 may transmit one or more control instructions to hardware scanner node 102 to activate one or more optical capture components as a primary capture modality and/or a supplemental capture modality for the capture session.

In some non-limiting embodiments or aspects, the one or more control instructions may cause hardware scanner node 102 to capture one or more images, video frames, infrared image frames, depth measurements, and/or other optical observations of one or more rooms, installation locations, equipment surfaces, device labels, and/or user-presented property-associated electronic devices 106 at real estate property 104. Record system 108 may process the raw optical data to derive supplemental device metadata including device class metadata, manufacturer metadata, model metadata, serial-number metadata, installation-location metadata, and/or one or more confidence values associated with identification of a respective property-associated electronic device 106. In some implementations, raw audio data captured during the capture session may be processed by record system 108 as supplemental environment data to detect audible device indicators, to receive participant-spoken annotations identifying a property-associated electronic device 106, to confirm room-by-room capture progression, and/or to associate spoken confirmation information with the structured device dataset. The supplemental device metadata derived from the raw optical data and/or the raw audio data may be used by record system 108 together with RF-derived observations to generate, supplement, validate, and/or complete the structured device dataset for the capture session. In some implementations, record system 108 may associate a participant-spoken annotation with a particular device record and/or room context based on one or more concurrently captured inputs including a capture timestamp, a room identifier, one or more optical observations captured during a same capture interval, one or more user interface events associated with the capture session, and/or one or more RF-derived observations obtained during the same capture interval. For example, when a participant provides a spoken annotation identifying a device while hardware scanner node 102 is capturing observations for a particular room, record system 108 may associate the spoken annotation with a candidate device record corresponding to that room, that capture interval, and/or one or more contemporaneously observed device features.

In some non-limiting embodiments or aspects, record system 108 may ingest and aggregate observed device metadata together with one or more supplemental entries received through the device intake interface to generate a candidate dataset for review. If a device is present at real estate property 104, but is not emitting detectable wireless signal emissions during the capture session, the candidate dataset may be supplemented through the device intake interface using photographic capture, voice-to-text entry, manual user input, and/or combinations thereof. The resulting candidate dataset may remain provisional until a subsequent confirmation event is recorded.

In some non-limiting embodiments or aspects, the trigger event that initiates scanning may be distinct from a subsequent confirmation event associated with finalization of the candidate dataset. For example, the seller may perform an affirmative digital confirmation action through a system interface by scanning a session QR code, accessing a confirmation link or portal, interacting with a mobile device interface associated with the capture session, selecting a confirmation control within the system interface, and/or performing another confirmation interaction. Through the system interface, the seller may confirm devices identified in the candidate dataset, remove devices that will not remain with real estate property 104 (e.g., that will not be included in the structured device dataset), add one or more devices, and/or correct one or more entries. Record system 108 may record the confirmation event together with associated metadata including a confirmation timestamp and/or a confirmation interaction performed through the system interface.

In some non-limiting embodiments or aspects, the confirmation event need not occur contemporaneously with the trigger event that initiates scanning. The confirmation event may occur immediately following the capture session and/or at a later time depending on seller availability, network connectivity, completion of additional capture inputs, supplemental manual entries, and/or other factors. In some embodiments, record system 108 may maintain the candidate dataset as provisional until the confirmation event is recorded, after which the confirmed dataset may be bound to the unique property identifier as the structured device dataset as described herein.

As previously described herein, in some non-limiting embodiments or aspects, hardware scanner node 102 may include a plurality of wireless communication interfaces, and different wireless communication interfaces of the plurality may be configured to receive different types of wireless signal emissions (e.g., emissions associated with different protocol families, frequency bands, modulation schemes, and/or discovery mechanisms). In such embodiments, scanning at step 306 may be performed using at least two wireless communication interfaces such that wireless signal emissions of different types may be received during a scanning operation. For example, scanning may be performed concurrently and/or sequentially using multiple wireless communication interfaces such that a first set of wireless signal emissions is received using a first wireless communication interface and a second set of wireless signal emissions is received using a second wireless communication interface, thereby increasing the set of property-associated electronic devices 106 that may be observed at real estate property 104.

In some non-limiting embodiments or aspects, scanning, at step 306, may be performed over a plurality of discovery cycles within a defined verification window. A discovery cycle may refer to, or correspond to, an instance of scanning performed during a defined interval, such as a scan pass, a channel scan sequence, and/or a scan dwell interval, and a verification window may refer to a time period that includes multiple discovery cycles. In such embodiments, the verification window may be defined by elapsed time (e.g., minutes or hours), by a count of discovery cycles, or by a combination thereof, and may be used to improve reliability by comparing repeated observations across discovery cycles prior to treating a device as confirmed for later inclusion in a structured device dataset. Intermediate scan observations for each discovery cycle may be stored locally (e.g., in storage component 208) and later aggregated across discovery cycles to support subsequent processing, including reducing transient detections (e.g., emissions from intermittently present devices, sporadic emissions, and/or spurious emissions) and increasing confidence that observed emissions correspond to devices physically associated with real estate property 104. In some non-limiting embodiments or aspects, the intermediate scan observations may include one or more of timestamps, signal strength values, channel identifiers, interface identifiers, and/or other reception context associated with received wireless signal emissions, thereby enabling subsequent steps to apply confirmation criteria and to generate a structured device dataset representing a confirmed device set of observed devices.

As shown in FIG. 3A, at step 308, process 300 may include: detecting one or more property-associated electronic devices based on received wireless signal emissions. For example, hardware scanner node 102 may detect one or more property-associated electronic devices 106 based on the received wireless signal emissions. In some non-limiting embodiments or aspects, detecting may include determining that a received wireless signal emission corresponds to a distinct device instance and generating a corresponding candidate device entry for subsequent processing. For example, hardware scanner node 102 may detect a device instance by identifying one or more externally observable identifiers contained in a received emission (e.g., a device address and/or other protocol-visible identifier) and creating or updating a corresponding candidate record maintained in memory 206 and/or storage component 208.

In some non-limiting embodiments or aspects, hardware scanner node 102 may maintain a candidate device list that represents devices tentatively observed based on locally receivable emissions and/or supplemental device metadata capture, and a confirmed device set that represents a subset of candidate entries that satisfy one or more confirmation criteria. For example, a candidate device entry may be created upon initial observation of a device address or other identifier and may be updated as additional observations are received in subsequent discovery cycles. Confirmation may include requiring repeated observations within a verification window, satisfying a confidence criterion derived from aggregated observations, corroboration across multiple wireless communication interfaces, user input, and/or other confirmation criteria described herein. In such embodiments, the structured device dataset and downstream artifacts may be generated based on or using the confirmed device set, while unconfirmed candidate entries may be retained separately for later reassessment without being treated as final infrastructure state. In this way, generating downstream structured device datasets and cryptographically verifiable artifacts using a confirmed device set rather than an unconfirmed candidate device list provides a more stable machine-readable infrastructure snapshot, reducing artifact churn and recomputation caused by transient or sporadic emissions.

In some non-limiting embodiments or aspects, detecting, at step 308, may include correlating observations across a plurality of discovery cycles within a defined verification window. For example, hardware scanner node 102 may maintain, for each candidate device entry, one or more observation attributes derived from the received wireless signal emissions, including one or more of: first-seen timestamp, last-seen timestamp, observation count, channel or interface identifiers associated with reception of the emissions, and/or signal strength values. In such embodiments, hardware scanner node 102 may reduce transient detections by requiring repeated observations of corresponding wireless signal emissions over multiple discovery cycles prior to confirming a detected device for inclusion in later processing (e.g., for inclusion in a confirmed device set, for inclusion in a structured device dataset).

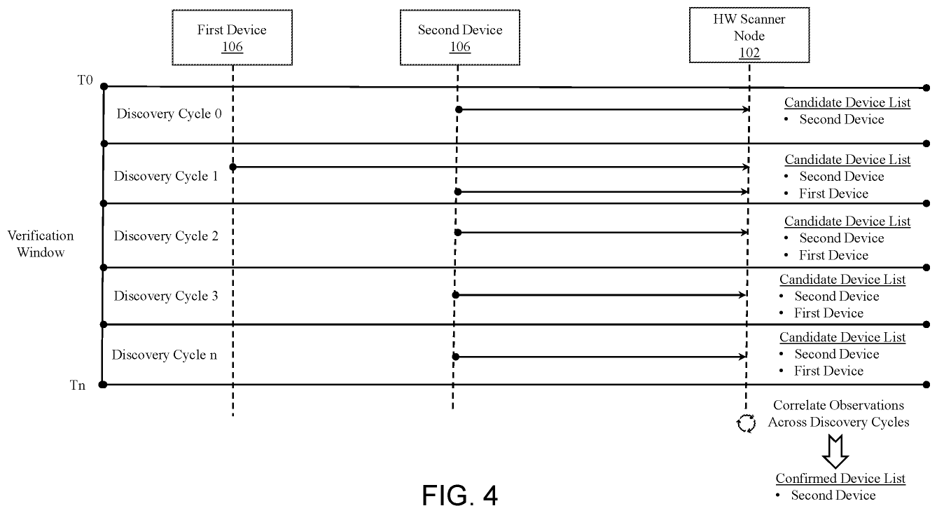

By way of example and without limitation, hardware scanner node 102 may confirm a detected device when corresponding emissions are observed in at least a threshold number of discovery cycles and/or when a confidence value derived from aggregated observations satisfies a predefined threshold. In some embodiments, the observation history used to compute the confidence value may include combining or corroborating observations received via different wireless communication interfaces as described herein. As an example, and referring also to FIG. 4, hardware scanner node 102 may receive wireless signal emissions from a second property-associated electronic device 106 in each of discovery cycles 0, 1, 2, 3, and n within a verification window, while hardware scanner node 102 may receive a wireless signal emission or emissions from first property-associated electronic device 106 only in discovery cycle 1. In such embodiments, hardware scanner node 102 may create and update a candidate device list as the verification window proceeds across the discovery cycles, such that the candidate device list may include entries for both first device 106 and second device 106 during at least a portion of the verification window. Hardware scanner node 102 may then correlate observations across discovery cycles and apply one or more confirmation criteria, as described herein, to generate a confirmed device set or list. In the illustrated example, second device 106 is included in the confirmed device set or list based on repeated observations across the discovery cycles, while first device 106 is excluded from the confirmed device set or list because the wireless signal emission from first device 106 is observed only in discovery cycle 1 and may be determined to correspond to a transient or sporadic device rather than a property-associated electronic device intended for inclusion in the structured device dataset.

In some non-limiting embodiments or aspects, a confidence value may be computed for a candidate device entry based on aggregated observations across discovery cycles, such as an observation count, persistence over time (e.g., first-seen/last-seen span), signal strength stability, and/or corroboration across multiple wireless communication interfaces. In such embodiments, a threshold number may specify a minimum count of discovery cycles in which corresponding emissions are observed, and a predefined threshold may specify a threshold confidence value (e.g., a threshold signal strength value, etc.) required for confirmation. For example, confirmation may require satisfying either a minimum cycle-count criterion or a confidence-value criterion, thereby reducing false positives due to transient or sporadic emissions.

In some non-limiting embodiments or aspects, where hardware scanner node 102 includes a plurality of wireless communication interfaces, detecting, at step 308, may include correlating emissions received on different wireless communication interfaces to a single candidate device entry. For example, a candidate device entry may be confirmed based on emissions received via at least two different wireless communication interfaces (e.g., emissions of different types and/or received on different bands), thereby improving robustness against false positives and intermittent emissions. In some non-limiting embodiments or aspects, hardware scanner node 102 may apply one or more de-duplication rules to reduce duplicate candidate entries (e.g., where multiple emissions correspond to the same physical device) and may maintain a mapping between multiple observed identifiers and a single candidate device entry where appropriate.

As shown in FIG. 3A, at step 310, process 300 may include: extracting, from received wireless signal emissions, device metadata associated with one or more property-associated electronic devices. For example, hardware scanner node 102 may extract, from the received wireless signal emissions, device metadata associated with one or more property-associated electronic devices 106. As an example, extracting device metadata may include parsing one or more PDUs associated with received wireless signal emissions and selecting one or more externally observable fields contained therein for inclusion in a device metadata record. For example, hardware scanner node 102 may parse PDUs to identify one or more device-visible identifiers and/or advertisement payload elements associated with a detected device instance and store extracted values in memory 206 and/or storage component 208.

In some non-limiting embodiments or aspects, a PDU may include any packet, frame, message, advertisement, beacon, management frame, discovery response, or other protocol-defined unit of data that is receivable over a wireless communication interface and that contains one or more fields usable for device identification or service discovery. In such embodiments, PDUs may be received passively (e.g., broadcast/advertisement traffic) and/or as responses elicited by active scanning and may be processed to extract device-visible identifiers and advertisement payload elements as described herein.

In some non-limiting embodiments or aspects, device metadata may include one or more externally observable fields derived from locally receivable wireless signal emissions and/or supplemental device metadata capture, including both (i) identity fields that tend to remain stable for a device (e.g., a device address, manufacturer identifier, and/or other protocol-visible identifiers) and (ii) capability or service fields that indicate how the device presents itself on a local wireless medium (e.g., service advertisement identifiers, manufacturer-specific data fields, and/or other discovery payload elements). In some non-limiting embodiments or aspects, device metadata may further include observation context associated with the underlying emissions (e.g., timestamp, signal strength, discovery-cycle identifier, channel identifier, and/or interface identifier) to support later confirmation, filtering, or reconciliation operations.

In some non-limiting embodiments or aspects, the extracted device metadata for a given property-associated electronic device 106 may include one or more of: a device address (e.g., a protocol-visible address), a device identifier, a manufacturer identifier, a service advertisement identifier, a manufacturer-specific data field, a protocol identifier, and/or other advertisement or discovery payload elements externally observable from received emissions. In some non-limiting embodiments or aspects, extracting device metadata further includes extracting reception context associated with the emissions from which the metadata was derived, including one or more of: timestamp, signal strength, channel identifier, interface identifier, and/or other reception attributes. In some non-limiting embodiments or aspects, hardware scanner node 102 may normalize one or more extracted fields into a canonical representation (e.g., normalizing address formatting, normalizing field encoding, and/or removing duplicate observations) prior to storing the device metadata.

In some non-limiting embodiments or aspects, a service advertisement identifier may include a service descriptor, service identifier, service UUID, or other advertisement element indicating a capability, role, or discoverable service of a device, and may be used to infer device category, device type, and/or supported integrations. In some non-limiting embodiments or aspects, a manufacturer-specific data field may include vendor-defined payload data contained within an advertisement or discovery response, such as a vendor identifier and vendor-specific bytes, which may be used to infer manufacturer, model family, and/or feature flags. In such embodiments, multiple service advertisement identifiers and/or manufacturer-specific data fields may be observed over time and aggregated to form a richer device metadata record.

In some non-limiting embodiments or aspects, a device address may include a protocol-visible address or identifier associated with a property-associated electronic device, such as a media access control (MAC) address, a Bluetooth device address, a short address, a network identifier, and/or another address-like field exposed in received emissions. In such embodiments, a device address may be used as a stable key for ordering device records, correlating repeated observations across discovery cycles, and/or de-duplicating candidate device entries.

In some non-limiting embodiments or aspects, extracting device metadata may include aggregating extracted fields across a plurality of discovery cycles within a verification window. For example, hardware scanner node 102 may update a device metadata record for a candidate device entry when additional PDUs are received for that device in subsequent discovery cycles, such that the device metadata record reflects repeated observations over time within a verification window. In such embodiments, hardware scanner node 102 may maintain multiple observed metadata elements for a device (e.g., multiple service advertisement identifiers observed over time) and may compute one or more summary values (e.g., most recently observed values, frequency counts, and/or confidence indicators) for inclusion in later processing.

In some non-limiting embodiments or aspects, hardware scanner node 102 may extract device metadata without establishing an authenticated session with a corresponding property-associated electronic device 106. For example, hardware scanner node 102 may perform extraction based on broadcast or advertisement traffic, discovery responses, and/or other externally observable emissions. In some non-limiting embodiments or aspects, extraction may be performed using passive observation of emissions and/or using emissions elicited by active scanning, as described herein. In some non-limiting embodiments or aspects, extracted device metadata may be stored locally as part of intermediate scan observations (e.g., as a candidate device set or list, as a confirmed device set or list, etc.) and later used to generate a structured device dataset (e.g., step 312) for provision to record system 108 (e.g., step 314).

In some non-limiting embodiments or aspects, supplemental device metadata may be captured to augment a candidate device set or list generated based on wireless signal emissions. For example, where one or more property-associated electronic devices 106 are not powered on, are temporarily offline, are configured to suppress emissions, or otherwise do not produce locally receivable wireless signal emissions during a scanning interval or verification window, supplemental information identifying such devices may be captured and associated with real estate property 104. In some non-limiting embodiments or aspects, the supplemental information may include one or more images of a property-associated electronic device 106 (e.g., an image of a device label, model identifier, installation location, or physical configuration), a voice annotation describing the device (e.g., “garage door controller,” “thermostat in hallway,” “camera at back patio”), and/or text input describing the device (e.g., make/model, device type, location within the property, installation notes, and/or other descriptive fields).

Supplemental device metadata may be captured by user device 110 (e.g., via a mobile phone application) and provided to hardware scanner node 102 and/or to record system 108 for association with the candidate device set or list, the confirmed device set or list, or the structured device set. Additionally or alternatively, hardware scanner node 102 may include one or more input components 210 (see, e.g., FIG. 2) configured to capture such supplemental device metadata directly at real estate property 104. For example, input component 210 may include one or more sensors such as an image capture device (e.g., a digital camera module, etc.) a microphone, and/or other input sensors configured to capture image, audio, and/or text input (e.g., via a touch input mechanism) usable to identify a device that is not currently emitting detectable wireless signal emissions. In some non-limiting embodiments or aspects, captured audio may be stored as audio data and/or converted to text (e.g., using speech-to-text processing) to generate metadata fields.

In some non-limiting embodiments or aspects, upon receiving or capturing supplemental device metadata, hardware scanner node 102 and/or record system 108 may update a candidate device list to include a candidate entry corresponding to the device identified by the supplemental device metadata, and may associate the candidate entry with one or more metadata fields derived from the supplemental device metadata (e.g., an image-derived device identifier, a user-selected device category, a location tag, and/or a transcribed voice annotation). In such embodiments, candidate entries derived from supplemental device metadata may be flagged as user-identified entries distinct from entries derived from wireless signal emissions and may be subject to subsequent confirmation logic (e.g., confirmation via user input, etc.) prior to inclusion in a structured device dataset and/or prior to generation of a confirmed structured device dataset and/or generation of cryptographic binding values and attestations, as described herein.

As shown in FIG. 3A, at step 312, process 300 may include: generating a structured device dataset including device metadata associated with one or more property-associated electronic devices. For example, hardware scanner node 102 may generate a structured device dataset including the device metadata associated with one or more property-associated electronic devices 106. In some non-limiting embodiments or aspects, hardware scanner node 102 may generate the structured device dataset by aggregating device metadata extracted from wireless signal emissions (e.g., as described with respect to steps 306-310) and organizing the device metadata into a set of device records, according to a defined schema. For example, hardware scanner node 102 may create a device record for each candidate device entry identified during scanning and detection operations and populate the device record with extracted fields, such as a device address, one or more service advertisement identifiers, one or more manufacturer-specific data fields, and/or other externally observable metadata fields derived from received PDUs.

In some non-limiting embodiments or aspects, the structured device dataset may include reception context and observation context associated with the device metadata. By way of example and without limitation, the structured device dataset may include, for each device record, one or more of: a first-seen time, a last-seen time, an observation count, one or more discovery-cycle identifiers, one or more interface identifiers indicating which wireless communication interface received corresponding emissions, one or more channel identifiers, and/or one or more signal strength values. In some non-limiting embodiments or aspects, hardware scanner node 102 may normalize one or more fields prior to inclusion in the structured device dataset (e.g., normalizing address formatting, normalizing encoding of manufacturer fields, and/or consolidating repeated observations), such that downstream processing may reliably compare and/or correlate device records over time.

In some non-limiting embodiments or aspects, hardware scanner node 102 may generate the structured device dataset based on the confirmed set or list of observed candidates. For example, hardware scanner node 102 may maintain a candidate device list based on locally receivable emissions and may apply one or more confirmation criteria (e.g., repeated detection across a plurality of discovery cycles within a verification window and/or satisfaction of a confidence threshold derived from aggregated observations) prior to including a corresponding device record in the confirmed set or list used to generate the structured device dataset. In some non-limiting embodiments or aspects, hardware scanner node 102 may include in the structured device dataset one or more flags or status indicators that distinguish between (i) device records derived solely from wireless signal emissions and (ii) device records supplemented by user-provided metadata, while preserving a machine-readable representation of the observations or user input that produced such records.

In some non-limiting embodiments or aspects, scanning for the wireless signal emissions, detecting one or more property-associated electronic devices 106, and extracting the device metadata may be performed over a plurality of discovery cycles within a defined verification window using at least two wireless communication interfaces of the plurality of wireless communication interfaces. In some embodiments, each property-associated electronic device 106 of the one or more property-associated electronic devices 106 may be included in the candidate device set or list, the confirmed device set or list, or the structured device dataset only upon (i) detection of corresponding wireless signal emissions associated with that property-associated electronic device 106 in at least a threshold number of the plurality of discovery cycles or (ii) a confidence value derived from the detected wireless signal emissions associated with that property-associated electronic device 106 across the plurality of discovery cycles satisfying a predefined threshold.

As previously described herein, the structured device dataset may include supplemental device metadata captured in addition to wireless signal emissions. For example, user device 110 and/or hardware scanner node 102 may provide image capture, voice annotation, and/or text input describing a property-associated electronic device 106 that is not emitting detectable wireless signal emissions during a defined verification window. In such embodiments, hardware scanner node 102 may incorporate one or more derived metadata fields from the supplemental information into a corresponding device record (e.g., an image-derived model identifier, a user-provided device category, a location tag, and/or a transcribed voice annotation), and may associate such device record with an indication that the record was user-identified and/or supplemented.

In some non-limiting embodiments or aspects, hardware scanner node 102 may generate the structured device dataset as an immutable point-in-time snapshot corresponding to a defined verification window, such that a subsequent defined verification window results in generation of a new structured device dataset rather than modification of the prior structured device dataset. Additionally or alternatively, hardware scanner node 102 may maintain version information and/or snapshot identifiers for structured device datasets generated at different times or in different verification windows (e.g., to support downstream correlation and time-based analysis). In some non-limiting embodiments or aspects, hardware scanner node 102 may store the structured device dataset locally in storage component 208 for subsequent provision to record system 108 as described herein.

As shown in FIG. 3B, at step 314, process 300 may include: providing a structured device dataset and/or property identifying data associated with a real estate property to at least one processor. For example, hardware scanner node 102 may provide the structured device dataset and/or property identifying data associated with real estate property 104 to record system 108. In some non-limiting embodiments or aspects, providing the structured device dataset and property identifying data associated with real estate property 104 includes packaging the structured device dataset and/or property identifying data associated with real estate property 104 for transmission and initiating delivery of the structured device dataset and property identifying data associated with real estate property 104 over one or more communication channels supported by hardware scanner node 102 and record system 108. For example, hardware scanner node 102 may serialize the structured device dataset into a machine-readable payload (e.g., according to a defined schema) and provide the payload to record system 108 using one or more wired and/or wireless network connections implemented by communication interface 214.

In some non-limiting embodiments or aspects, property identifying data may include one or more data elements associated with real estate property 104 that are usable by record system 108 to identify, determine, retrieve, and/or otherwise resolve a unique property identifier associated with real estate property 104. For example, property identifying data may include property address data, canonicalized property address data, geospatial location data, normalized geospatial location data, a hierarchical location encoding, one or more hierarchical location components, one or more parcel identifiers, assessor parcel numbers, registry identifiers, jurisdictional descriptors, unit designators, and/or other location-related or property-related descriptors associated with real estate property 104. In some non-limiting embodiments or aspects, property identifying data may be received, stored, transmitted, and/or processed as a structured object including a plurality of fields, one or more machine-readable values derived from such fields, and/or another data representation. Record system 108 may use the property identifying data to identify a previously generated unique property identifier associated with real estate property 104, as further described herein with respect to step 318.

In some implementations, record system 108 may provide the unique property identifier associated with real estate property 104 to hardware scanner node 102 prior to deployment of hardware scanner node 102 at real estate property 104 and/or prior to scanning by hardware scanner node 102, such that the unique property identifier itself is included in or used as the property identifying data subsequently provided to record system 108.

In some non-limiting embodiments or aspects, providing the structured device dataset includes establishing a secure communication channel between hardware scanner node 102 and record system 108 prior to transmission. For example, hardware scanner node 102 may establish an encrypted session (e.g., a transport-layer security (TLS) session and/or another authenticated encrypted session) with record system 108 and may provide the structured device dataset using encrypted application programming interface (API) communications. In some non-limiting embodiments or aspects, providing the structured device dataset may include device authentication and/or mutual authentication between hardware scanner node 102 and record system 108 (e.g., using certificates, tokens, shared secrets, and/or other credentials) to reduce the risk of unauthorized dataset injection and to enable record system 108 to associate the structured device dataset with an authorized hardware scanner node deployment. In this way, establishing an authenticated encrypted session and performing device authentication and/or mutual authentication prior to dataset delivery provides a technical security improvement by preventing spoofed or replayed dataset injection at the sensing-to-record boundary and enabling early rejection of unauthenticated payloads before downstream processing and artifact generation.

In some non-limiting embodiments or aspects, hardware scanner node 102 may provide the structured device dataset together with one or more associated artifacts, such as dataset context information (e.g., verification window identifier, timestamp, and/or snapshot identifier) and/or scanner attestation data as described herein. In some non-limiting embodiments or aspects, the structured device dataset may be provided as a single payload, as a sequence of payloads (e.g., chunked transmission), and/or using a message-oriented delivery mechanism.

In some non-limiting embodiments or aspects, hardware scanner node 102 may generate scanner attestation data for the structured device dataset and may provide the scanner attestation data together with the structured device dataset to record system 108. A scanner attestation may include attestation data associated with a scan output and may include at least a scanner integrity value derived from scanner node state information and a corresponding scanner digital signature. In some embodiments, hardware scanner node 102 may generate the scanner integrity value by applying a cryptographic hash function to scanner node state information associated with hardware scanner node 102 and may generate the scanner digital signature over at least the scanner integrity value. Hardware scanner node 102 may then transmit the structured device dataset together with the scanner attestation to record system 108 for downstream processing.

In some non-limiting embodiments or aspects, the scanner node state information may include one or more of firmware or software build identifiers, software version identifiers, configuration information, scanning routine identifiers, enabled interface identifiers, enabled protocol families, scan timing parameters, boot-time indicators, uptime indicators, and/or one or more other state descriptors usable to characterize an operational state and scan configuration of hardware scanner node 102 at a time of scan and that materially affect scan behavior and generation of the structured device dataset. By providing the structured device dataset together with the scanner attestation, hardware scanner node 102 may enable record system 108 to evaluate integrity and provenance of the structured device dataset prior to generation and/or storage of one or more downstream artifacts described herein.

As shown in FIG. 3B, at step 316, process 300 may include: receiving a structured device dataset including device metadata associated with one or more property-associated electronic devices located at a real estate property and property identifying data associated with the real estate property. For example, record system 108 may receive (e.g., from hardware scanner node 102, etc.) the structured device dataset including the device metadata associated with one or more property-associated electronic devices 106 located at real estate property 104 and the property identifying data associated with real estate property 104. In such an example, receiving the structured device dataset may include accepting an incoming payload at a communication interface (e.g., communication interface 214 of one or more devices 200 implementing record system 108) and storing the received payload (or a parsed representation thereof) in memory 206 and/or storage component 208 for subsequent processing.

In some non-limiting embodiments or aspects, receiving the structured device dataset may further include receiving and processing scanner attestation data provided with the structured device dataset. A scanner attestation may include attestation data associated with a scan output, including at least a scanner integrity value derived from scanner node state information and a corresponding scanner digital signature and/or other cryptographic proof usable to validate scanner integrity and authorization. For example, hardware scanner node 102 may provide the structured device dataset together with a scanner attestation including (i) a scanner integrity value generated by applying a cryptographic hash function to scanner node state information associated with hardware scanner node 102 and (ii) a scanner digital signature over at least the scanner integrity value. The scanner node state information may include one or more of firmware or software build identifiers, software version identifiers, configuration information, scanning routine identifiers, enabled interface identifiers, enabled protocol families, scan timing parameters, boot-time indicators, uptime indicators, and/or one or more other state descriptors usable to characterize an operational state and scan configuration of hardware scanner node 102 at a time of scan and that materially affect scan behavior and structured device dataset generation.

Record system 108 may validate the scanner attestation as part of a trusted acquisition pipeline prior to accepting the structured device dataset for downstream processing. For example, record system 108 may maintain a scanner node trust store including scanner public keys, certificates, and/or other trust material corresponding to authorized scanner nodes and may use the scanner node trust store to validate the scanner digital signature received with the structured device dataset. In some embodiments, record system 108 may generate a scanner validation result indicating whether the scanner attestation is valid, whether a corresponding scanner public key is authorized, and/or whether verification fails due to a revoked key, an unrecognized key, or an invalid signature.

In some non-limiting embodiments or aspects, record system 108 may gate acceptance of the structured device dataset, state transitions, and/or artifact generation based on the scanner validation result. For example, record system 108 may accept the structured device dataset for downstream processing when scanner attestation verification succeeds and may otherwise quarantine, reject and/or label the structured device dataset as untrusted. In some implementations, when scanner attestation verification fails, record system 108 may prevent generation of a unified property metadata profile based on the structured device dataset, prevent generation of a cryptographic binding value and/or a cryptographic attestation for the structured device dataset, prevent storage of the structured device dataset as a verifiable point-in-time artifact, request a rescan, request additional attestation data, apply increased verification requirements for subsequent datasets from hardware scanner node 102, and/or temporarily suspend acceptance of datasets from hardware scanner node 102 until re-enrollment and/or re-provisioning occurs. Additionally or alternatively, record system 108 may record scanner attestation failures as tamper-evident events and/or expose an attestation status indicator as associated metadata for later auditing and/or third-party verification. Upon successful scanner attestation validation, record system 108 may proceed with generating one or more downstream artifacts as described herein.

As shown in FIG. 3B, at step 318, process 300 may include: identifying or retrieving, based on property identifying data, a unique property identifier for a real estate property. For example, record system 108 may identify or retrieve, based on the property identifying data, the unique property identifier for real estate property 104. As an example, record system 108 may use the property identifying data to identify or retrieve the unique property identifier associated with real estate property 104. For example, record system 108 may compare the property identifying data to stored property-related data maintained in association with a plurality of unique property identifiers and may identify or retrieve the unique property identifier based on a correspondence or match between the property identifying data and corresponding stored data. In some non-limiting embodiments or aspects, record system 108 may perform the identification or retrieval using a look-up table, a database query, an index structure, a key-value store, a search operation, and/or another data retrieval technique. For example, record system 108 may query a data store using one or more fields of the property identifying data, such as property address data, canonicalized property address data, geospatial location data, normalized geospatial location data, a hierarchical location encoding, one or more other property-related descriptors, and/or the unique property identifier, to identify a corresponding record associated with real estate property 104 and retrieve the unique property identifier associated therewith. In some implementations, in which the property identifying data includes the unique property identifier itself previously provided to hardware scanner node 102 by record system 108 prior to deployment and/or scanning, record system 108 may correspond or match the unique property identifier included in the property identifying data to a known unique property identifier of the plurality of unique property identifiers stored by record system 108. In some non-limiting embodiments or aspects, where multiple fields are available, record system 108 may use two or more portions of the property identifying data in combination to improve matching accuracy and/or resolve ambiguity among candidate property records.

In some implementations, identifying the unique property identifier may include determining whether the real estate property is represented in the pre-instantiated property identity infrastructure described herein. For example, record system 108 may receive property identifying data for real estate property 104 and may normalize, canonicalize, and/or otherwise standardize one or more portions of the property identifying data to facilitate comparison against data stored in association with the pre-instantiated property identity infrastructure. In some examples, record system 108 may compare one or more portions of the property identifying data, such as property address data, canonicalized property address data, geospatial location data, normalized geospatial location data, hierarchical location encoding data, parcel-related data, and/or one or more other property-related descriptors, to corresponding data maintained in association with the plurality of unique property identifiers of the property identity infrastructure. In some implementations, the property identifying data received for real estate property 104 may include the unique property identifier itself, such as where the unique property identifier was previously provided to hardware scanner node 102 by record system 108 prior to deployment and/or scanning. In such implementations, record system 108 may identify the unique property identifier for real estate property 104 by corresponding to or matching the unique property identifier included in the property identifying data to a known unique property identifier of the plurality of unique property identifiers stored by record system 108. Based on the comparison, correspondence, and/or match, record system 108 may identify a corresponding property record within the property identity infrastructure and may retrieve, from the property record, the unique property identifier associated with real estate property 104. In this manner, record system 108 may identify the unique property identifier by retrieving a previously instantiated unique property identifier from the property identity infrastructure based on a correspondence between the property identifying data and stored property-related data.

In some implementations, retrieval of the unique property identifier from the property identity infrastructure may include querying one or more data repositories, databases, index structures, key-value stores, search structures, and/or region-specific datasets associated with the property identity infrastructure. For example, record system 108 may determine, from the property identifying data, a candidate geographic region associated with real estate property 104 and may use the candidate geographic region to select a corresponding regional dataset of the property identity infrastructure for searching and/or retrieval. In some examples, record system 108 may search within the selected regional dataset for a property record corresponding to the property identifying data and may retrieve the unique property identifier maintained in association with that property record. In some further examples, record system 108 may additionally verify that the retrieved unique property identifier is included in the property identity infrastructure by reference to one or more cryptographic commitments associated with the regional dataset, such as a corresponding Merkle root, content-addressed storage identifier, blockchain transaction identifier, timestamp, and/or registry contract record. Thus, in implementations in which the real estate property is already represented in the pre-instantiated property identity infrastructure, record system 108 may identify the unique property identifier by locating the corresponding property record in the property identity infrastructure and retrieving the pre-instantiated unique property identifier associated therewith.

As shown in FIG. 3B, at step 320, process 300 may include: generating a unified property metadata profile including a unique property identifier and a structured device dataset. For example, record system 108 may generate a unified property metadata profile including the unique property identifier and the structured device dataset. In some non-limiting embodiments or aspects, generating the unified property metadata profile may include generating a machine-readable profile object, document, record, and/or other data structure that associates the unique property identifier for real estate property 104 with the structured device dataset representing one or more property-associated electronic devices 106 confirmed at real estate property 104.

In some non-limiting embodiments or aspects, the unified property metadata profile may include a property identity portion and a device data portion. For example, the property identity portion may include the unique property identifier and/or one or more associated context fields, and the device data portion may include the structured device dataset and/or a reference thereto. In some implementations, the unified property metadata profile may further include one or more contextual fields associated with generation of the unified property metadata profile, such as a profile timestamp, a verification window identifier, a schema version indicator, a profile version indicator, a scanner node identifier, a scanner validation result indicator, and/or one or more other associated metadata values.

In some non-limiting embodiments or aspects, record system 108 may generate the unified property metadata profile according to a defined schema and/or a deterministic ordering. For example, record system 108 may canonicalize one or more fields of the structured device dataset prior to inclusion in the unified property metadata profile, including canonical formatting for one or more identifiers, canonical encoding for one or more manufacturer fields, consistent handling of missing values, and/or other normalization operations. Additionally or alternatively, record system 108 may apply one or more ordering rules to device records of the structured device dataset, such as ordering the device records based on a device address and/or another deterministic identifier. In some implementations, record system 108 may generate a canonical serialized representation of the unified property metadata profile such that identical inputs produce identical serialized profile representations.

In some non-limiting embodiments or aspects, the unified property metadata profile may correspond to a point-in-time profile generated prior to receipt of user confirmation described herein in more detail with respect to step 324 and prior to generation of the confirmed structured device dataset and the confirmed unified property metadata profile described herein with respect to step 326. For example, the structured device dataset included in the unified property metadata profile generated at step 320 may be based on candidate observations, confirmed observations identified by hardware scanner node 102 within a verification window, supplemental device metadata, and/or combinations thereof, prior to user review and confirmation. In some implementations, record system 108 may maintain the unified property metadata profile generated at step 320 as a provisional and/or pre-confirmation profile pending receipt of user input associated with the structured device dataset.

In some non-limiting embodiments or aspects, record system 108 may generate a plurality of unified property metadata profiles for real estate property 104 at different times without modifying a previously generated unified property metadata profile. For example, record system 108 may generate a first unified property metadata profile based on a first received structured device dataset and may generate a second unified property metadata profile based on a later received structured device dataset. In such embodiments, record system 108 may store each unified property metadata profile as a separate artifact associated with the unique property identifier for real estate property 104, thereby enabling later review, comparison, auditing, and/or verification of property-associated electronic devices 106 observed at different points in time.

As shown in FIG. 3B, at step 322, process 300 may include: providing a unified property metadata profile to at least one user device. For example, record system 108 may provide the unified property metadata profile to user device 110. For example, record system 108 may provide access to the unified property metadata profile to user device 110 for presentation of the structured device dataset included therein, such that a user of user device 110 may review one or more property-associated electronic devices 106 represented in the structured device dataset prior to finalization of the structured device dataset. As an example, providing the unified property metadata profile to user device 110 may include enabling or causing user device 110 to access and present the unified property metadata profile in a review interface and/or a confirmation interface associated with the capture session for real estate property 104. In some implementations, user device 110 may be a mobile device or another computing device executing a browser, a web-based interface, an application, and/or other client-side software configured to access the unified property metadata profile at record system 108 and/or another system that stores the unified property metadata profile and to present one or more workflow outputs associated therewith, including candidate device information, confirmation prompts, and/or one or more other review outputs described herein.

In some non-limiting embodiments or aspects, the unified property metadata profile provided to user device 110 may correspond to a provisional and/or pre-confirmation profile generated from the structured device dataset received from hardware scanner node 102. For example, record system 108 may provide the unified property metadata profile to user device 110 and/or may provide user device 110 with access to the unified property metadata profile stored by record system 108 and/or another system, such that the structured device dataset may be reviewed by a property participant, a seller, and/or the like through a system interface before the structured device dataset is finalized. In some implementations, the system interface may include the web-based interface, the application, and/or another interface presented by user device 110 and may present one or more device records derived from detected wireless signal emissions and/or one or more supplemental entries received through a device intake interface. The unified property metadata profile may remain provisional pending receipt of a subsequent confirmation event associated with the structured device dataset.

As shown in FIG. 3C, at step 324, process 300 may include: receiving, from at least one user device, a user input associated with the structured device dataset. For example, record system 108 may receive, from user device 110, a user input associated with the structured device dataset. As an example, the user input may include at least one of the following: a confirmation of at least one desired property-associated electronic device of one or more property-associated electronic devices 106 in the structured device dataset, a request to remove at least one undesired property-associated electronic device of one or more property-associated electronic devices 106 in the structured device dataset, a request to add at least one additional desired property-associated electronic device to one or more property-associated electronic devices 106 in the structured device dataset, or any combination thereof. In such an example, the user input may include device metadata associated with the at least one additional desired property-associated electronic device and/or device metadata data associated with the at least one desired property-associated electronic device (e.g., supplemental device metadata updating or revising the device metadata already associated with the at least one desired property-associated electronic device in the structured device dataset, etc.).

In some non-limiting embodiments or aspects, the user input may be received via a system interface presented by user device 110 after user device 110 accesses the unified property metadata profile from record system 108 and/or another system storing the unified property metadata profile. For example, user device 110 may access the unified property metadata profile via a web-based interface, an application executing on user device 110, and/or another client-side interface, and record system 108 may receive the user input through the system interface. In some embodiments, the user input may correspond to a participant confirmation event associated with the structured device dataset, and record system 108 may record the participant confirmation event together with associated metadata including a confirmation timestamp, a confirmation interaction performed through the system interface, an identifier associated with user device 110, and/or one or more other confirmation-related metadata values. Record system 108 may maintain the structured device dataset and/or the unified property metadata profile in a provisional state pending receipt of the user input. As an example, the user input may include the request to add the at least one additional desired property-associated electronic device to the one or more property-associated electronic devices 106 in the structured device dataset, and the user input may include additional device metadata associated with the at least one additional desired property-associated electronic device. In some embodiments, the additional device metadata may include at least one of image data, audio data, text data, or any combination thereof.

In some non-limiting embodiments or aspects, the user input may include a participant confirmation event including an affirmative confirmation action by a property participant confirming the structured device dataset presented through the system interface. For example, the property participant may review one or more device records included in the structured device dataset and may submit, through user device 110, an affirmative confirmation input indicating that the structured device dataset, as optionally modified by removal of one or more undesired property-associated electronic devices, addition of one or more desired property-associated electronic devices, correction of one or more entries, or any combination thereof, is confirmed for use in generating the confirmed structured device dataset. In some non-limiting embodiments or aspects, record system 108 may withhold generation of the cryptographic attestation until after receipt of the participant confirmation event used to generate the confirmed structured device dataset and the confirmed unified property metadata profile.

In some non-limiting embodiments or aspects, the participant confirmation event may comprise a confirmation timestamp recording a date and time at which the affirmative confirmation action is received and a confirmation method identifier identifying a modality through which the affirmative confirmation action is performed. For example, the confirmation method identifier may identify that the affirmative confirmation action was received through a web-based interface, a native application interface, a mobile interface, an authenticated session interface, and/or one or more other system-interface modalities. In some implementations, record system 108 may associate the confirmation timestamp and the confirmation method identifier with the structured device dataset and the confirmed unified property metadata profile generated based on the participant confirmation event.

As shown in FIG. 3C, at step 326, process 300 may include: generating, based on user input, a confirmed structured device dataset and a confirmed unified property metadata profile including the confirmed structured device dataset and the unique property identifier. For example, record system 108 may generate, based on the user input, a confirmed structured device dataset and a confirmed unified property metadata profile including the confirmed structured device dataset and the unique property identifier. As an example, the confirmed structured device dataset may include the at least one desired property-associated electronic device (and/or metadata associated therewith) of one or more property-associated electronic devices 106 confirmed, by the user input, in the structured device dataset and/or the at least one additional desired property-associated electronic device (and/or metadata associated therewith) requested to be added, by the user input, to one or more property-associated electronic devices 106 in the structured device dataset. In such an example, the confirmed structured device dataset may not include the at least one undesired property-associated electronic device (and/or metadata associated therewith) requested to be removed, by the user input, from one or more property-associated electronic devices 106 in the structured device dataset.

In some non-limiting embodiments or aspects, generating the confirmed structured device dataset may include modifying the structured device dataset based on the user input. For example, record system 108 may generate the confirmed structured device dataset by confirming, based on the user input, the at least one desired property-associated electronic device of one or more property-associated electronic devices 106 in the structured device dataset, removing, based on the user input, the at least one undesired property-associated electronic device of one or more property-associated electronic devices 106 in the structured device dataset, and/or adding, based on the user input, the at least one additional desired property-associated electronic device to one or more property-associated electronic devices 106 in the structured device dataset. In such an example, record system 108 may further update the structured device dataset to include device metadata associated with the at least one additional desired property-associated electronic device and/or device metadata associated with the at least one desired property-associated electronic device, such as supplemental device metadata updating or revising device metadata already associated with the at least one desired property-associated electronic device in the structured device dataset.

In some non-limiting embodiments or aspects, generating the confirmed unified property metadata profile may include associating the confirmed structured device dataset with the unique property identifier associated with real estate property 104. For example, after generating the confirmed structured device dataset based on the user input, record system 108 may generate the confirmed unified property metadata profile to include the confirmed structured device dataset and the unique property identifier for real estate property 104. In some embodiments, the confirmed unified property metadata profile may include a confirmed, point-in-time representation of one or more property-associated electronic devices 106 associated with real estate property 104 based on confirmation, removal, and/or addition of one or more property-associated electronic devices 106 reflected in the user input.

In this way, record system 108 may generate the confirmed structured device dataset and the confirmed unified property metadata profile after receipt of a participant confirmation event associated with the structured device dataset. For example, record system 108 may maintain the structured device dataset and/or the unified property metadata profile in a provisional state prior to generation of the confirmed structured device dataset and the confirmed unified property metadata profile and may generate the confirmed structured device dataset and the confirmed unified property metadata profile after the user input associated with the structured device dataset is received from user device 110.

As shown in FIG. 3C, at step 328, process 300 may include: generating a cryptographic binding value for a confirmed unified property metadata profile by applying a cryptographic hash function to at least a unique property identifier and a confirmed structured device dataset in combination. For example, record system 108 may generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value. As an example, record system 108 may generate the cryptographic binding value by generating a canonical binding input corresponding to the confirmed unified property metadata profile and applying the cryptographic hash function to the canonical binding input. In such an example, the canonical binding input may include a deterministic representation of at least the unique property identifier and the confirmed structured device dataset in combination. In some implementations, the canonical binding input may be generated using a defined ordering and serialization scheme, such that identical inputs produce identical canonical binding inputs across different computing environments.

In some non-limiting embodiments or aspects, record system 108 may generate the canonical binding input by combining a canonical representation of the unique property identifier and a canonical representation of the confirmed structured device dataset in a predetermined ordering. For example, record system 108 may apply fixed ordering rules, fixed formatting rules, and/or fixed handling of null or missing values such that independent implementations produce the same serialized representation for the same underlying semantic content. In some implementations, canonical serialization may include ordering device records of the confirmed structured device dataset using a stable key, applying consistent field ordering within a device record, and/or applying consistent delimiter encoding, length encoding, and/or field labeling for composite structures.

In some non-limiting embodiments or aspects, record system 108 may exclude non-deterministic fields from the canonical binding input and may include fields intended to be integrity-protected. For example, record system 108 may exclude transient transport headers, routing metadata, session-specific transmission metadata, and/or one or more other non-deterministic values that vary across transmissions, while including at least the unique property identifier and the confirmed structured device dataset. In this manner, the cryptographic binding value may remain stable for the same confirmed unified property metadata profile even when the confirmed unified property metadata profile is transmitted, stored, reformatted, and/or re-encoded in different computing environments.

In some non-limiting embodiments or aspects, record system 108 may apply the cryptographic hash function to the canonical binding input to generate the cryptographic binding value. The cryptographic hash function may be configured to produce a fixed-length digest that is sensitive to changes in the canonical binding input. For example, even a small change to the unique property identifier and/or the confirmed structured device dataset may result in a different cryptographic binding value, thereby enabling subsequent integrity verification of the confirmed unified property metadata profile.

In some non-limiting embodiments or aspects, the cryptographic binding value may be treated as a cryptographic commitment to the confirmed unified property metadata profile, including the association between the unique property identifier and the confirmed structured device dataset. For example, record system 108 and/or another verifier (e.g., user device 110, etc.) may later recompute the cryptographic binding value from a retrieved unique property identifier and a retrieved confirmed structured device dataset using the same canonicalization and hashing rules and may compare the recomputed cryptographic binding value to a stored cryptographic binding value to detect modification, substitution, and/or corruption of the confirmed unified property metadata profile. In this manner, generation of the cryptographic binding value may provide a technical mechanism for integrity verification of a participant-confirmed, property-bound device record.

In some non-limiting embodiments or aspects, use of the canonical binding input may improve deterministic reproducibility and interoperability of verification operations across heterogeneous computing environments. For example, where the same confirmed structured device dataset may otherwise be represented using different syntactic forms, canonical serialization may reduce false mismatches during verification by ensuring that identical semantic content produces the same canonical representation prior to hashing. In this manner, different systems may recompute the cryptographic binding value from the same confirmed unified property metadata profile and obtain a matching result, thereby improving reliability of cross-system verification and reducing verification failures attributable to formatting differences rather than changes in protected content.

In some non-limiting embodiments or aspects, record system 108 may generate the cryptographic binding value using a composite hashing construction. For example, record system 108 may generate one or more component digests for one or more portions of the confirmed structured device dataset and may combine the component digests into an aggregate digest, such as a Merkle root and/or a chained digest, that is used together with the unique property identifier to generate the cryptographic binding value. In some implementations, this construction may enable efficient verification of integrity for less than all of the confirmed structured device dataset, may reduce bandwidth and processing overhead associated with verification, and/or may support selective disclosure of less than all of the confirmed structured device dataset while preserving cryptographic integrity protection for the confirmed unified property metadata profile.

As shown in FIG. 3C, at step 330, process 300 may include: generating a digital signature over a cryptographic binding value for a confirmed unified property metadata profile using a private cryptographic key to produce a cryptographic attestation that binds the confirmed structured device dataset to the unique property identifier. For example, record system 108 may generate a digital signature over the cryptographic binding value for the confirmed unified property metadata profile using a private cryptographic key to produce a cryptographic attestation that binds the confirmed structured device dataset to the unique property identifier.

In some non-limiting embodiments or aspects, record system 108 may generate the cryptographic attestation by applying a digital signature algorithm to the cryptographic binding value for the confirmed unified property metadata profile using the private cryptographic key. For example, record system 108 may select a private cryptographic key associated with an issuing authority and may apply the digital signature algorithm to the cryptographic binding value to generate a digital signature. In such embodiments, the cryptographic attestation may include the digital signature and may bind the confirmed structured device dataset to the unique property identifier through the cryptographic binding value.

In some non-limiting embodiments or aspects, the cryptographic attestation may include the digital signature together with one or more associated attestation fields. For example, the cryptographic attestation may include one or more of an attestation identifier, an issuance timestamp, a key identifier, a signature algorithm identifier, a certificate reference, and/or one or more other context fields usable to support verification of the digital signature. In some implementations, the cryptographic attestation may be represented as a structured attestation object configured to be stored, transmitted, and/or processed together with the cryptographic binding value and/or the confirmed unified property metadata profile.

In some non-limiting embodiments or aspects, the one or more associated attestation fields may include one or more participant-confirmation fields derived from the participant confirmation event used to generate the confirmed structured device dataset. For example, the cryptographic attestation may include, as embedded data fields within the cryptographic attestation, the confirmation timestamp and the confirmation method identifier associated with the affirmative confirmation action by the property participant. In such embodiments, the confirmation timestamp and the confirmation method identifier may be included in the attestation content covered by the digital signature, such that subsequent validation of the digital signature using the corresponding public cryptographic key verifies integrity of the confirmation timestamp and the confirmation method identifier together with integrity of the confirmed structured device dataset and the unique property identifier. In this manner, the cryptographic attestation may provide a machine-verifiable indication not only of what property-bound device record was confirmed, but also when and through what confirmation modality the participant confirmation event occurred.

In some non-limiting embodiments or aspects, record system 108 may manage the private cryptographic key using one or more key management mechanisms. For example, the private cryptographic key may be stored in a protected key store, a hardware security module, a trusted execution environment, and/or one or more other protected cryptographic storage mechanisms, and record system 108 may invoke a signing operation through a controlled signing interface, such that the private cryptographic key is not exposed in plaintext to application processes. In some implementations, record system 108 may rotate signing keys over time and may include a key identifier and/or certificate reference in the cryptographic attestation to support subsequent verification using a corresponding public cryptographic key.

In some non-limiting embodiments or aspects, record system 108 may generate the cryptographic attestation after one or more prerequisite conditions are satisfied. For example, record system 108 may generate the cryptographic attestation after successful validation of scanner attestation data associated with the structured device dataset and after receipt of the user input used to generate the confirmed structured device dataset and the confirmed unified property metadata profile. In this manner, generation of the cryptographic attestation may be gated on both trusted acquisition and participant confirmation, such that record system 108 does not generate a cryptographic attestation for an unconfirmed and/or untrusted device dataset. This gating may improve integrity of downstream property-bound artifacts by reducing the likelihood that a cryptographically attested artifact is generated from tampered scanner output, transient observations, and/or unconfirmed device information.

In some non-limiting embodiments or aspects, the digital signature may be verifiable using a corresponding public cryptographic key such that a verifier may determine whether the cryptographic binding value has been modified after generation of the cryptographic attestation. For example, because the cryptographic binding value is generated for the confirmed unified property metadata profile based on at least the unique property identifier and the confirmed structured device dataset in combination, validation of the digital signature using the corresponding public cryptographic key may enable verification of integrity of both the confirmed structured device dataset and the unique property identifier. In this manner, the cryptographic attestation may provide a machine-verifiable mechanism for verifying integrity of a participant-confirmed, property-bound device record without requiring reliance on a trusted intermediary at the time of verification.

In some non-limiting embodiments or aspects, generating the cryptographic attestation may improve technical operation of distributed verification systems by enabling independent verification of integrity and origin of the confirmed unified property metadata profile across different systems and computing environments. For example, a downstream verifier may obtain the cryptographic binding value and the cryptographic attestation, validate the digital signature using the corresponding public cryptographic key, and verify that the confirmed structured device dataset remains bound to the unique property identifier reflected in the confirmed unified property metadata profile. In such embodiments, use of the digital signature over the cryptographic binding value may improve interoperability, reduce reliance on platform-specific trust assumptions at verification time, and provide a cryptographically verifiable control point for issuance of downstream property metadata artifacts.

As shown in FIG. 3C, at step 332, process 300 may include: storing a confirmed unified property metadata profile and a cryptographic attestation for the confirmed unified property metadata profile such that subsequent validation of a digital signature using a corresponding public cryptographic key verifies integrity of both a confirmed structured device dataset and the unique property identifier. For example, record system 108 may store the confirmed unified property metadata profile and the cryptographic attestation for the confirmed unified property metadata value, such that subsequent validation of the digital signature using a corresponding public cryptographic key verifies integrity of both the confirmed structured device dataset and the unique property identifier

In some non-limiting embodiments or aspects, storing may include persisting the confirmed unified property metadata profile and the cryptographic attestation in one or more data repositories associated with record system 108 in a manner that preserves an association among the confirmed unified property metadata profile, the cryptographic binding value, and the cryptographic attestation. For example, record system 108 may store the confirmed unified property metadata profile and the cryptographic attestation as a point-in-time artifact associated with the unique property identifier for real estate property 104. In some implementations, the point-in-time artifact may further include the cryptographic binding value and/or one or more associated metadata fields, such as a profile timestamp, an attestation identifier, an issuance timestamp, a key identifier, a signature algorithm identifier, a scanner validation result indicator, and/or one or more other verification-related metadata values.

In some non-limiting embodiments or aspects, storing the confirmed unified property metadata profile and the cryptographic attestation may further include storing a canonical serialized representation of the confirmed unified property metadata profile and/or sufficient information to deterministically reconstruct the canonical serialized representation. For example, record system 108 may store the cryptographic binding value used to generate the cryptographic attestation and one or more canonicalization context fields, such as a schema version indicator, canonical ordering rules, formatting rules, and/or handling rules for null or missing values. In this manner, a verifier may subsequently retrieve the confirmed unified property metadata profile and the cryptographic attestation, recompute the cryptographic binding value using the same canonicalization and hashing rules, and validate the digital signature using the corresponding public cryptographic key to confirm integrity of both the confirmed structured device dataset and the unique property identifier.

In some non-limiting embodiments or aspects, record system 108 may store the confirmed unified property metadata profile and the cryptographic attestation as an immutable point-in-time artifact and may inhibit and/or prevent modification of a previously stored point-in-time artifact. For example, record system 108 may store each point-in-time artifact in a versioned object store, write-once storage configuration, append-only storage configuration, and/or one or more other storage mechanisms configured such that an update is performed by creating a new point-in-time artifact rather than modifying a previously stored point-in-time artifact. In some implementations, each point-in-time artifact may be associated with an artifact identifier and an artifact timestamp, and record system 108 may maintain an index enabling retrieval of a plurality of historical point-in-time artifacts associated with the same unique property identifier.

In some non-limiting embodiments or aspects, record system 108 may maintain a tamper-evident history of stored point-in-time artifacts associated with the unique property identifier. For example, record system 108 may generate an audit log entry for a stored point-in-time artifact, where the audit log entry includes an artifact identifier, a digest computed over at least the confirmed unified property metadata profile and the cryptographic attestation, and/or a reference digest corresponding to another audit log entry. In some implementations, the reference digest may include a hash pointer such that audit log entries are cryptographically linked in sequence, thereby enabling later detection of modification, deletion, and/or insertion of an audit log entry and improving integrity of stored artifact history.

In some non-limiting embodiments or aspects, a plurality of point-in-time artifacts associated with the same unique property identifier may correspond to a plurality of capture sessions performed at different times for real estate property 104. For example, a first capture session may include receiving a structured device dataset associated with one or more property-associated electronic devices 106 located at real estate property 104, generating a confirmed structured device dataset and a confirmed unified property metadata profile including the unique property identifier, generating a cryptographic attestation for the confirmed unified property metadata profile, and storing the confirmed unified property metadata profile and the cryptographic attestation as a first point-in-time artifact associated with the unique property identifier. In some implementations, a subsequent capture session associated with the same unique property identifier may include subsequently receiving a subsequent structured device dataset associated with one or more property-associated electronic devices 106 located at real estate property 104, generating a subsequent confirmed structured device dataset and a subsequent confirmed unified property metadata profile including the same unique property identifier, generating a subsequent cryptographic attestation for the subsequent confirmed unified property metadata profile, and storing the subsequent confirmed unified property metadata profile and the subsequent cryptographic attestation as a subsequent point-in-time artifact associated with the unique property identifier.

In some non-limiting embodiments or aspects, the subsequent cryptographic attestation may be cryptographically linked to the cryptographic attestation generated for the first capture session. For example, the subsequent cryptographic attestation may include, as one or more associated attestation fields, a reference to the cryptographic attestation generated for the first capture session, an attestation identifier of the cryptographic attestation generated for the first capture session, a cryptographic hash of the cryptographic attestation generated for the first capture session, a cryptographic hash of a canonical representation of the cryptographic attestation generated for the first capture session, or any combination thereof. In such embodiments, the subsequent cryptographic attestation may be digitally signed with the one or more associated attestation fields including the reference to, and/or the cryptographic hash of, the cryptographic attestation generated for the first capture session, such that subsequent validation of the digital signature verifies the cryptographic linkage between the subsequent cryptographic attestation and the cryptographic attestation generated for the first capture session. In this manner, the cryptographic attestation generated for the first capture session and the subsequent cryptographic attestation generated for the subsequent capture session may form part of a verifiable lifecycle record associated with the unique property identifier. In this way, cryptographically linking a subsequent cryptographic attestation to an earlier cryptographic attestation for the same unique property identifier may improve machine-verifiable longitudinal validation of property-associated electronic device metadata by permitting a verifier to confirm evolution of point-in-time artifacts across multiple capture sessions without altering or replacing earlier stored artifacts. In this manner, the system may preserve immutability of prior point-in-time artifacts while enabling efficient verification of a chained lifecycle record associated with the unique property identifier across time and across ownership transfers of real estate property 104.

In some non-limiting embodiments or aspects, record system 108 may store the confirmed unified property metadata profile and the cryptographic attestation in a hybrid storage architecture. For example, record system 108 may store the confirmed unified property metadata profile and/or the cryptographic attestation in one or more persistent data repositories and may store a cryptographic commitment corresponding thereto in a tamper-evident ledger and/or one or more other tamper-evident data structures. In such embodiments, the cryptographic commitment may be usable to verify that a retrieved confirmed unified property metadata profile and a retrieved cryptographic attestation correspond to previously stored content. In this manner, storage of the confirmed unified property metadata profile and the cryptographic attestation may improve resilience of verification operations across heterogeneous storage systems and may reduce reliance on any single mutable repository as the sole source of integrity assurance.

In some non-limiting embodiments or aspects, record system 108 may store and/or maintain one or more public cryptographic keys, certificate references, and/or other verification materials usable for later validation of the digital signature. For example, record system 108 may maintain a public key repository and/or certificate store that enables a verifier to identify the corresponding public cryptographic key based on a key identifier and/or certificate reference associated with the cryptographic attestation. Additionally or alternatively, record system 108 may store one or more scanner validation results and/or one or more other acquisition-integrity indicators as associated metadata for the confirmed unified property metadata profile, thereby enabling later auditing of whether the confirmed unified property metadata profile was generated based on a structured device dataset that satisfied required integrity checks prior to generation of the cryptographic attestation.

In some non-limiting embodiments or aspects, the stored confirmed unified property metadata profile and the stored cryptographic attestation may be retrieved and independently validated by an authorized verifier. For example, record system 108 may provide a verification interface, such as an application programming interface, a portal interface, and/or one or more other retrieval mechanisms, through which an authorized verifier (e.g., via user device 110, etc.) obtains the confirmed unified property metadata profile, the cryptographic attestation, and/or one or more associated verification materials. In some implementations, the authorized verifier may use the corresponding public cryptographic key to validate the digital signature included in the cryptographic attestation and may recompute the cryptographic binding value from the retrieved confirmed unified property metadata profile using the canonicalization and hashing rules described herein. In this manner, the authorized verifier may independently verify integrity of both the confirmed structured device dataset and the unique property identifier without reliance on mutable intermediate records.

In some non-limiting embodiments or aspects, storing the confirmed unified property metadata profile and the cryptographic attestation, as described herein, may improve technical operation of distributed verification systems by enabling repeatable validation of a participant-confirmed, property-bound device record across different systems and computing environments. For example, storage of the confirmed unified property metadata profile together with the cryptographic attestation, the cryptographic binding value, and/or canonicalization context may improve deterministic reproducibility of verification operations, while immutable storage and/or tamper-evident history mechanisms may improve detection of post-storage modification. In this manner, step 332 may provide a technical improvement in integrity-preserving storage, interoperable verification, and auditability of cryptographically verifiable property metadata artifacts.

### Non-Limiting Example Property Lifecycle Operations

In some non-limiting embodiments or aspects, systems and methods described herein may support one or more property lifecycle operations performed by record system 108 after generation and storage of a confirmed unified property metadata profile and a cryptographic attestation, as described herein. In such embodiments, the property lifecycle operations may support lifecycle transitions associated with real estate property 104, generation of compliance-oriented outputs, and/or controlled access to one or more stored property-related artifacts by authorized stakeholders. In some non-limiting embodiments or aspects, the property lifecycle operations described herein may be implemented according to an event-driven model in which record system 108 performs one or more state transitions and/or generates one or more point-in-time artifacts in response to one or more defined workflow triggers and/or events, rather than through continuous polling and/or continuous monitoring of one or more property-associated electronic devices 106 at real estate property 104.

In some non-limiting embodiments or aspects, record system 108 may operate with a plurality of deployed hardware scanner nodes at a plurality of real estate properties and may maintain node eligibility information associated with the plurality of deployed hardware scanner nodes. For example, record system 108 may determine node eligibility information based on successful validation of scanner attestations, dataset delivery reliability, reporting cadence consistency, observed error rates, and/or one or more other acquisition-integrity indicators associated with a given hardware scanner node. In such embodiments, record system 108 may use the node eligibility information to gate acceptance of one or more structured device datasets, prioritize one or more processing operations, and/or apply additional verification requirements to one or more structured device datasets received from a hardware scanner node exhibiting one or more integrity anomalies. Additionally or alternatively, record system 108 may store the node eligibility information as associated metadata and/or as one or more tamper-evident records to support subsequent auditing.

### Handoff

In some non-limiting embodiments or aspects, systems and methods described herein may support a post-transfer handoff workflow for real estate property 104 in which an authorized subsequent user initiates a handoff protocol to establish updated control of one or more property-associated electronic devices 106 and/or one or more related property artifacts. In some embodiments, the handoff protocol may be initiated in response to an activation event associated with hardware scanner node 102 and/or user device 110, such as access via a machine-readable code associated with hardware scanner node 102, access to an activation link, access to a portal, access to a secure session link, and/or another activation mechanism associated with real estate property 104. In such embodiments, record system 108 may associate the activation event with the unique property identifier, one or more stored point-in-time artifacts, and/or one or more associated metadata values, and may determine one or more post-transfer actions to be performed for real estate property 104.

In some non-limiting embodiments or aspects, record system 108 may obtain one or more ownership validation inputs associated with real estate property 104 prior to enabling one or more handoff operations. For example, the one or more ownership validation inputs may include one or more transaction-related references, title-related references, escrow-related references, listing-related references, and/or one or more other closing-related identifiers associated with real estate property 104. In such embodiments, record system 108 may determine whether one or more ownership validation criteria are satisfied and may store an ownership validation result as associated metadata linked to the unique property identifier and/or one or more point-in-time artifacts associated with real estate property 104.

In some non-limiting embodiments or aspects, ownership validation may be performed using one or more external validation services configured to provide confirmation of one or more ownership transition events. For example, record system 108 may query one or more third-party data sources associated with real estate property 104, including listing data, title data, escrow data, transaction records, and/or one or more other external data sources, and may determine whether one or more ownership validation criteria are satisfied based on one or more responses received therefrom. Additionally or alternatively, record system 108 may use an oracle-based validation workflow in which an external oracle service provides a signed validation response indicating that an ownership transition condition is satisfied. In such embodiments, record system 108 may gate one or more post-transfer actions on successful validation of the signed validation response and may store one or more digests of one or more ownership-validation inputs, one or more ownership-validation outputs, and/or the signed validation response as associated metadata for subsequent auditing.

In some non-limiting embodiments or aspects, after ownership validation, record system 108 may perform a vault reissue operation and one or more related access-control updates to transition a credential vault associated with the unique property identifier from a prior-user state to a subsequent-user state. For example, record system 108 may reset vault access for a subsequent authorized user, issue one or more new login credentials for the credential vault, and maintain one or more vault state indicators and/or vault lifecycle events reflecting the handoff. In such embodiments, the vault reissue operation may occur in coordination with one or more vault lock operations to reduce the likelihood that a prior user will retain access after transfer of occupancy and/or ownership.

In some non-limiting embodiments or aspects, the handoff protocol may further include generation of one or more post-transfer verification artifacts. For example, after initiation of the handoff protocol, hardware scanner node 102 may generate one or more subsequent structured device datasets associated with real estate property 104, and record system 108 may generate one or more additional confirmed unified property metadata profiles and/or one or more additional cryptographic attestations, based thereon, to enable verification of one or more post-transfer device states and/or one or more differences relative to one or more pre-transfer point-in-time artifacts. In such embodiments, record system 108 may preserve one or more previously stored point-in-time artifacts as immutable and independently verifiable, while generating one or more subsequent point-in-time artifacts corresponding to post-transfer device state.

In some non-limiting embodiments or aspects, the one or more additional cryptographic attestations generated after transfer of real estate property 104 may be associated with the same unique property identifier previously assigned to real estate property 104 and may be cryptographically linked to one or more earlier cryptographic attestations generated before the transfer. For example, an additional cryptographic attestation generated from a post-transfer capture session may include a reference to, or a cryptographic hash of, a cryptographic attestation generated from a pre-transfer capture session, such that the pre-transfer cryptographic attestation and the post-transfer cryptographic attestation are linked across the transfer event. In this manner, record system 108 may maintain, for the same unique property identifier, a verifiable lifecycle record of property-associated electronic device metadata across ownership transfers of real estate property 104 while preserving each corresponding point-in-time artifact as immutable and independently verifiable.

### Audit Process

In some non-limiting embodiments or aspects, record system 108 may perform an audit process associated with real estate property 104 based on one or more structured device datasets generated by hardware scanner node 102 and provided to record system 108 as described herein. In such embodiments, the audit process may include generation of a soft audit artifact and/or a hard audit artifact. For example, the soft audit artifact may correspond to an initial point-in-time representation based on a received structured device dataset and associated context, and the hard audit artifact may correspond to an enhanced representation generated after one or more additional verification and/or refinement operations are performed by record system 108.

In some non-limiting embodiments or aspects, record system 108 may generate one or more audit artifacts as machine-readable objects that are storable as one or more point-in-time artifacts and/or cryptographically verifiable artifacts as described herein. For example, record system 108 may generate one or more audit artifacts including one or more device inventory representations, one or more audit indicators derived from device metadata and/or observation context, one or more device categorization outputs, one or more remediation guidance outputs, one or more action lists, and/or combinations thereof. In some embodiments, record system 108 may generate a human-readable report derived from the audit artifact and may store the human-readable report in association with the corresponding point-in-time artifact.

In some non-limiting embodiments or aspects, record system 108 may compute one or more risk scores and/or classification indicators for one or more device records based on one or more weighted factor models associated with device metadata. For example, record system 108 may determine the one or more risk scores and/or classification indicators based on device category, monitoring capability, access-control capability, one or more observable device attributes, and/or one or more other device-related factors. In such embodiments, record system 108 may include the one or more risk scores and/or classification indicators in an audit artifact and/or as associated metadata linked to a point-in-time artifact to enable subsequent prioritization of one or more remediation actions.

In some non-limiting embodiments or aspects, the audit process may be implemented using a combination of automated assessment and human review. For example, record system 108 may receive one or more structured device datasets and may apply one or more automated analysis rules and/or one or more machine-learning-based classification routines to generate one or more audit indicators, one or more categorization outputs, and/or one or more recommended actions. Additionally or alternatively, record system 108 may enable one or more users associated with user device 110 to provide input through one or more interfaces, including confirming one or more device categories, adding one or more notes, resolving one or more ambiguous device records, and/or otherwise supplementing the audit process.

In some non-limiting embodiments or aspects, record system 108 may generate the soft audit artifact by transforming a structured device dataset into a preliminary audit representation and may perform one or more verification and/or refinement operations to produce the hard audit artifact. For example, the one or more verification and/or refinement operations may include ingesting one or more additional structured device datasets captured at different times, incorporating supplemental device metadata, and/or applying one or more reconciliation and/or consistency checks to improve completeness and reduce uncertainty. In such embodiments, record system 108 may generate one or more confirmed unified property metadata profiles, one or more cryptographic binding values, and/or one or more cryptographic attestations corresponding to the audit artifact as described herein, thereby enabling independent verification of integrity of one or more stored audit-related artifacts.

### Deregistration and Evidence-of-Wipe

In some non-limiting embodiments or aspects, systems and methods described herein may implement a wipe process configured to reduce the likelihood that a prior occupant and/or prior owner retains access to one or more property-associated electronic devices 106 associated with real estate property 104 after a transfer of occupancy and/or ownership. In such embodiments, the wipe process may include performing one or more technical actions to remove, revoke, reset, and/or otherwise disable one or more prior-user associations for one or more property-associated electronic devices 106, and may further include generating one or more machine-readable records indicating performance of the one or more technical actions.

In some non-limiting embodiments or aspects, the wipe process may include collecting evidence-of-wipe for one or more wipe tasks and associating the evidence-of-wipe with one or more corresponding device records. For example, the evidence-of-wipe may include one or more machine-readable evidence artifacts indicating performance of one or more wipe tasks for a device, and a wipe evidence object may include a stored record including or referencing one or more such evidence artifacts in association with a device record and related wipe workflow metadata. In some embodiments, user device 110 may capture and provide one or more evidence artifacts including one or more of screenshots, screen recordings, videos, images, confirmations, and/or one or more other machine-readable proofs indicating that a device has been removed from a prior-user account, reset, and/or otherwise deregistered.

In some non-limiting embodiments or aspects, record system 108 may evaluate evidence-of-wipe prior to treating a wipe workflow instance as complete. A wipe workflow instance may include an identifiable wipe-process session associated with real estate property 104 and, optionally, one or more property-associated electronic devices 106 for which one or more per-device wipe tasks are tracked. In some embodiments, record system 108 may apply one or more automated checks to one or more evidence artifacts and/or may record one or more reviewer confirmations indicating that one or more submitted evidence artifacts satisfy one or more wipe completion criteria. Additionally or alternatively, record system 108 may maintain one or more per-device wipe status indicators and may generate a wipe completion status for the wipe workflow instance based on the one or more per-device wipe status indicators.

In some non-limiting embodiments or aspects, completion of the wipe workflow instance may be recorded as a lifecycle event associated with the unique property identifier and may be used to gate one or more subsequent vault lock operations, one or more subsequent vault reissue operations, and/or one or more post-transfer access grants. In some embodiments, record system 108 may generate a wipe completion artifact associated with real estate property 104 and may bind the wipe completion artifact and/or one or more associated evidence digests to the unique property identifier using one or more cryptographic mechanisms described herein.

In some non-limiting embodiments or aspects, the wipe process may include one or more post-wipe verification operations. For example, after one or more wipe tasks are performed and one or more evidence artifacts are submitted, hardware scanner node 102 may generate one or more subsequent structured device datasets reflecting device infrastructure state after the wipe process. In such embodiments, record system 108 may compare a pre-wipe structured device dataset and a post-wipe structured device dataset to identify one or more differences and/or detect one or more discrepancies, including one or more newly present devices, one or more devices that remain present but are not verified as wiped, and/or one or more other discrepancies. In some embodiments, the one or more discrepancies may trigger an exception state, a request for additional evidence, and/or one or more additional wipe tasks.

In some non-limiting embodiments or aspects, following completion of the wipe process, record system 108 may cause one or more device access relationships to be re-established under a property-tied identity artifact and may store one or more resulting credential objects and/or access-control artifacts in a credential vault as described herein. In this manner, comparison of a pre-wipe structured device dataset and a post-wipe structured device dataset to detect discrepancies may provide an automated technical verification mechanism for identifying residual device presence and/or incomplete deregistration without requiring per-device manual inspection, thereby improving reliability of post-transfer security-state transitions.

### Blockchain Artifact Packaging and Role-Based Access Control

In some non-limiting embodiments or aspects, record system 108 may implement role-based access control for one or more property-related artifacts using one or more blockchain smart contracts and/or one or more token standards. A property-related artifact may include a stored machine-readable object associated with real estate property 104, including one or more of a structured device dataset, a confirmed unified property metadata profile, a cryptographic binding value, a cryptographic attestation, an audit artifact, a wipe completion artifact, and/or associated metadata used for verification, lifecycle operations, and/or controlled access. In some embodiments, access permissions may be associated with one or more roles and one or more cryptographic credentials, and one or more smart contracts may govern issuance, renewal, and/or revocation of one or more role-based access credentials and may log one or more access-control events in a tamper-evident manner for subsequent auditing.

In some non-limiting embodiments or aspects, record system 108 may support a utility-token access model associated with the unique property identifier and/or one or more property-related artifacts, wherein token state is usable to gate issuance, renewal, and/or revocation of one or more role-based access credentials and/or one or more permission scopes. For example, record system 108 may maintain, for a property, a token allocation that is initially locked and/or restricted and that becomes eligible for use upon satisfaction of one or more protocol-completion conditions, including completion of an audit workflow, completion of a wipe workflow instance, successful ownership validation, generation of a confirmed unified property metadata profile, generation of a cryptographic attestation, and/or one or more other conditions described herein.

In some non-limiting embodiments or aspects, the blockchain smart contract may maintain a role registry that maps (i) the unique property identifier and/or one or more artifact identifiers to (ii) one or more roles and corresponding permission scopes and to (iii) one or more cryptographic identifiers for authorized parties. In such embodiments, a permission scope may include a machine-readable specification of one or more allowed operations for an authorized party and, optionally, one or more associated constraints, including one or more permitted artifact types, one or more permitted actions, one or more expiration times, one or more effective windows, one or more request quotas, and/or combinations thereof. In some embodiments, the smart contract may implement one or more state-transition functions to grant, renew, revoke, and/or update a role and may emit corresponding tamper-evident events enabling later reconstruction of authorization state from event history.

In some non-limiting embodiments or aspects, record system 108 may store, on-chain, one or more compact verification materials and one or more locator references for a property-related artifact, while storing a primary artifact payload off-chain. For example, for a given property-related artifact, record system 108 may store an artifact identifier, a digest of the artifact and/or a digest of a canonical serialized representation thereof, and a locator reference as token metadata and/or smart-contract state, while storing the property-related artifact itself in one or more data repositories. In such embodiments, an independent verifier may retrieve the compact verification material, retrieve the referenced property-related artifact, recompute the digest, and/or validate provenance using one or more cryptographic techniques described herein. In this manner, storing one or more compact digests and one or more locator references on-chain while maintaining one or more primary artifact payloads off-chain may improve storage efficiency, bandwidth efficiency, and/or auditability while preserving independent integrity verification.

In some non-limiting embodiments or aspects, record system 108 may generate a tokenized certification artifact for a stored property-related artifact and may include, within token metadata, one or more integrity fields associated with generation of the stored property-related artifact. For example, a tokenized certification artifact may include a tokenized representation of a stored property-related artifact that includes and/or references one or more verification materials usable by an independent verifier to assess integrity and/or provenance. In some embodiments, token metadata may include one or more attestation-derived fields, one or more key identifiers, one or more certificate references, one or more digests, and/or one or more other verification-context fields usable to identify one or more corresponding public cryptographic keys and/or evaluate provenance of the stored property-related artifact.

In some non-limiting embodiments or aspects, record system 108 may enforce time-bounded and/or quota-bounded access controls for retrieval and/or use of one or more artifacts and/or services described herein. For example, record system 108 may issue one or more time-limited access grants and/or one or more quota-limited access grants tied to an access scope identifier specifying which artifacts and/or services are enabled for the access grant. In such embodiments, record system 108 may revoke and/or disable access upon expiration and/or quota exhaustion and may log one or more access-grant lifecycle events as associated metadata linked to the unique property identifier and/or one or more artifact identifiers.

In some non-limiting embodiments or aspects, record system 108 may support governance of one or more protocol parameters using one or more voting mechanisms implemented via one or more smart contracts and/or one or more approval rules. By way of example and without limitation, governed parameters may include one or more access-policy parameters, one or more validation-policy parameters, and/or one or more lifecycle-policy parameters. In such embodiments, record system 108 may apply an approved parameter update as a versioned policy change and may log the policy update event in a tamper-evident manner, such that subsequent verification of an artifact and/or an access decision may be evaluated relative to an applicable policy version.

### Non-Limiting Example Implementations

Example Hardware Scanner Node Implementation. In some non-limiting embodiments or aspects, hardware scanner node 102 may be implemented as a compact embedded computing device configured for on-site deployment at real estate property 104, including a processor, memory, and local storage for buffering one or more scan observations and/or one or more structured device datasets. By way of example and without limitation, hardware scanner node 102 may be implemented using a single-board computer with integrated and/or attached non-volatile storage and one or more wireless communication interfaces configured to receive locally receivable wireless signal emissions. In such embodiments, hardware scanner node 102 may include one or more physical interfaces for power and/or diagnostics and one or more user-feedback indicators and/or user-input controls. In this manner, providing a dedicated on-site hardware scanner node 102 with local compute, persistent storage, and one or more wireless communication interfaces may enable robust acquisition of locally receivable device metadata under real-world wireless conditions while reducing dependence on continuous network connectivity.

In some non-limiting embodiments or aspects, hardware scanner node 102 may support one or more provisioning modes for associating hardware scanner node 102 with the unique property identifier and enabling secure communications with record system 108, including a pre-configured deployment mode and/or a local onboarding mode. In such embodiments, hardware scanner node 102 may provide one or more structured device datasets to record system 108 using secure communications and may include one or more integrity fields and/or scanner attestation data, as described herein, thereby enabling record system 108 to validate integrity and origin of scan outputs prior to generating one or more confirmed unified property metadata profiles and/or one or more cryptographically verifiable artifacts.

Example Ingestion, Audit, and Report Generation Workflow Implementation. In some non-limiting embodiments or aspects, record system 108 may implement a structured ingestion workflow in which a user device application submits a structured device dataset generated by hardware scanner node 102 together with supplemental property metadata through an interface that validates schema conformance, enforces field mappings, and associates the submission with the unique property identifier. In such embodiments, record system 108 may generate a soft audit artifact from the submitted structured device dataset and may apply one or more automated assessment routines to generate one or more audit indicators, one or more device categorization outputs, and/or one or more recommended actions, optionally supplemented by one or more human-review inputs received via a user interface. Additionally or alternatively, record system 108 may generate a human-readable report derived from a machine-readable audit artifact and may deliver the human-readable report via one or more messaging mechanisms, while storing the human-readable report in association with a corresponding point-in-time artifact, such that integrity of the human-readable report is verified using one or more cryptographic techniques described herein.

In some non-limiting embodiments or aspects, after generation of a soft audit artifact and/or a report, record system 108 may support continuation into a wipe workflow instance in which a user submits evidence-of-wipe for one or more property-associated electronic devices 106 and record system 108 evaluates the evidence-of-wipe and generates a wipe completion artifact and/or updates wipe completion status as described herein. In such embodiments, record system 108 may generate a property-tied identity artifact and may generate and/or update a credential vault associated with the unique property identifier to store one or more credential objects and/or one or more access-control artifacts for one or more property-associated electronic devices 106, including revoking one or more prior-user access rights and performing a vault reissue operation for a subsequent authorized user as part of a handoff workflow. Additionally or alternatively, record system 108 may generate a hard audit artifact and/or a final report package and may generate a tokenized certification artifact for the stored report package and/or another property-related artifact, thereby enabling subsequent stakeholders to retrieve and independently verify integrity and provenance, as described herein.

Example Distributed Verification and Interoperability Implementation. In some non-limiting embodiments or aspects, record system 108 may implement distributed verification and controlled access for one or more property-related artifacts using one or more distributed ledger networks and associated smart-contract logic, while maintaining one or more primary artifact payloads off-chain. For example, record system 108 may store, in smart-contract state and/or token metadata, one or more compact verification materials and one or more references for a property-related artifact, including an artifact identifier, a digest of the artifact and/or a digest of a canonical serialized representation thereof, and a locator reference, and may log one or more access-control events as tamper-evident events, as described herein. In such embodiments, a verifier may retrieve the compact verification material, obtain the referenced property-related artifact from storage, recompute the digest, and validate provenance using one or more cryptographic verification techniques described herein. In this manner, storing only compact verification materials and one or more references in distributed ledger state may reduce storage consumption and bandwidth consumption while enabling independent integrity verification and auditability without reliance on mutable access logs.

In some non-limiting embodiments or aspects, record system 108 may interoperate across multiple networks by using an oracle workflow and/or a cross-network messaging workflow to confirm one or more off-chain conditions and to propagate one or more state changes associated with one or more property lifecycle operations. For example, record system 108 may obtain a signed oracle response indicating satisfaction of an ownership validation condition and may gate one or more subsequent actions on validation of the signed oracle response, and record system 108 may use a cross-network messaging mechanism to replicate and/or reference one or more tokenized certification artifacts, one or more access grants, and/or one or more audit-state indicators across networks. Additionally or alternatively, record system 108 may use verifiable randomness to support one or more randomized selection events and/or one or more reward-distribution events for network participation consistent with configured policy. In this manner, oracle-validated gating and cross-network propagation may provide a technical interoperability mechanism that preserves verification consistency across heterogeneous networks while reducing duplicated processing and enabling policy-controlled automation of lifecycle state transitions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method for generating a cryptographically verifiable property-associated electronic device metadata record for a real estate property, comprising:
receiving, with at least one processor, a structured device dataset including device metadata associated with one or more property-associated electronic devices located at the real estate property;
identifying or retrieving, with the at least one processor, a unique property identifier for the real estate property;
generating, with the at least one processor, a unified property metadata profile including the unique property identifier for the real estate property and the structured device dataset;
providing, with the at least one processor, the unified property metadata profile to at least one user device;
receiving, with the at least one processor, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof;
generating, with the at least one processor, based on the user input, a confirmed structured device dataset and a confirmed unified property metadata profile including the confirmed structured device dataset and the unique property identifier;
generating, with the at least one processor, a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value;
generating, with the at least one processor, a digital signature over the cryptographic binding value for the confirmed unified property metadata profile using a private cryptographic key to produce a cryptographic attestation that binds the confirmed structured device dataset to the unique property identifier; and
storing, with the at least one processor, the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

2. The method of claim 1, further comprising:
deploying a hardware scanner node at the real estate property, the hardware scanner node including at least one wireless communication interface configured to receive wireless signal emissions within a reception range of the at least one wireless communication interface;
scanning, with the hardware scanner node using the at least one wireless communication interface, for wireless signal emissions associated with one or more property-associated electronic devices located at the real estate property;
detecting, with the hardware scanner node, the one or more property-associated electronic devices based on the received wireless signal emissions;
extracting, with the hardware scanner node from the received wireless signal emissions, device metadata associated with the one or more property-associated electronic devices;
generating, with the hardware scanner node, the structured device dataset including the device metadata associated with the one or more property-associated electronic devices; and
providing, with the hardware scanner node, the structured device dataset to the at least one processor.

3. The method of claim 2, wherein the hardware scanner node is configured to extract the device metadata and transmit the structured device dataset including the device metadata to the at least one processor without performing, on the device metadata, a local address normalization operation, a local property identity resolution operation, a local device fingerprint matching operation, or any combination thereof,
wherein the at least one processor performs the address normalization operation, the property identity resolution operation, and the device fingerprint matching operation on the device metadata included in the structured device dataset received from the hardware scanner node, and
wherein the hardware scanner node initiates scanning for the wireless signal emissions only after receiving, from the at least one processor, a session authorization confirmation associated with an authorized capture session for the real estate property, such that scanning by the hardware scanner node is bounded to the authorized capture session.

4. The method of claim 3, wherein the hardware scanner node comprises a sensor array device configured to capture raw audio data, raw RF signal data, and raw optical data associated with the real estate property and to provide, to the at least one processor, the raw audio data, the raw RF signal data, the raw optical data, and/or device metadata derived therefrom without performing, at the hardware scanner node, the local address normalization operation, the local property identity resolution operation, the local device fingerprint matching operation, or any combination thereof,
wherein the scanning for the wireless signal emissions comprises a first authorization stage in which a property participant grants network access to the hardware scanner node thereby enabling RF-based detection of the wireless signal emissions,
wherein the user input comprises a second authorization stage in which the property participant confirms the structured device dataset prior to generation of the cryptographic attestation, and
wherein the at least one processor activates optical data capture as a primary or supplemental capture modality when RF-based detection of the wireless signal emissions is unavailable or insufficient.

5. The method of claim 2, wherein the hardware scanner node includes a plurality of wireless communication interfaces,
wherein each wireless communication interface of the plurality of wireless communication interfaces is configured to receive a different type of wireless signal emission,
wherein scanning for the wireless signal emissions, detecting the one or more property-associated electronic devices, and extracting the device metadata are performed by the hardware scanner node over a plurality of discovery cycles within a defined verification window using at least two wireless communication interfaces of the plurality of wireless communication interfaces, and
wherein each property-associated electronic device of the one or more property-associated electronic devices is included in the structured device dataset only upon (i) detection of corresponding wireless signal emissions associated with that property-associated electronic device in at least a threshold number of the plurality of discovery cycles or (ii) a confidence value derived from the detected wireless signal emissions associated with that property-associated electronic device across the plurality of discovery cycles satisfying a predefined threshold.

6. The method of claim 2, wherein receiving, with the at least one processor, the structured device dataset includes:
receiving the structured device dataset together with a scanner attestation, the scanner attestation including (i) a scanner integrity value generated by applying a cryptographic hash function to scanner node state information associated with the hardware scanner node and (ii) a scanner digital signature over the scanner integrity value; and
validating the scanner digital signature using a corresponding scanner public key to generate a scanner validation result, and
wherein the unified property metadata profile is generated in response to the scanner validation result indicating that the scanner digital signature is valid.

7. The method of claim 2, further comprising:
generating, with the at least one processor, the unique property identifier for the real estate property, wherein the unique property identifier for the real estate property is generated before deploying the hardware scanner node at the real estate property and independently of scanning, with the hardware scanner node using the at least one wireless communication interface, for the wireless signal emissions associated with the one or more property-associated electronic devices located at the real estate property.

8. The method of claim 7, wherein generating, with the at least one processor, the unique property identifier for the real estate property includes:
obtaining property address data associated with the real estate property;
applying a salting operation to the property address data to generate salted property address data; and
processing the salted property address data using a deterministic key generation algorithm to produce the unique property identifier,
wherein processing the salted property address data using the deterministic key generation algorithm includes applying a cryptographic one-way function or a key derivation function (KDF) to the salted property address data to produce the unique property identifier, and
wherein applying the salting operation includes combining the property address data with a salt value, the salt value being derived from at least one of a platform secret, a per-property secret, or a version-specific secret.

9. The method of claim 8, wherein generating, with the at least one processor, the unique property identifier for the real estate property includes generating, with the at least one processor, a plurality of unique property identifiers for a plurality of real estate properties by:
obtaining, for each real estate property of the plurality of real estate properties, corresponding property address data associated with that real estate property;
applying, for each real estate property of the plurality of real estate properties, the salting operation to the corresponding property address data associated with that real estate property to generate corresponding salted property address data for that real estate property;
processing, for each real estate property of the plurality of real estate properties, the corresponding salted property address data for that real estate property using the deterministic key generation algorithm to produce a corresponding unique property identifier for that real estate property; and
storing, in a data repository, the plurality of unique property identifiers for the plurality of real estate properties, wherein the corresponding unique property identifier for each real estate property is stored in association with the corresponding property address data associated with that real estate property.

10. The method of claim 9, wherein storing, in the data repository, the plurality of unique property identifiers for the plurality of real estate properties comprises pre-instantiating, the plurality of unique property identifiers as a property identity infrastructure, the storing further including:
generating a plurality of regional Merkle roots representing respective portions of data associated with the plurality of unique property identifiers;
pinning data corresponding to the plurality of regional Merkle roots to a content-addressed distributed file system to generate a corresponding plurality of content identifiers; and
anchoring the corresponding plurality of content identifiers to a blockchain using a corresponding plurality of blockchain transaction hashes, such that the property identity infrastructure is cryptographically committed in a tamper-evident and time-verifiable manner.

11. The method of claim 8, wherein generating, with the at least one processor, the unique property identifier further includes:
generating canonicalized property address data by normalizing the property address data according to one or more normalization rules;
obtaining geospatial location data associated with the real estate property; and
generating normalized geospatial location data by converting the geospatial location data to a predetermined precision,
wherein applying the salting operation includes applying the salting operation to a combination of the canonicalized property address data and the normalized geospatial location data to generate the salted property address data,
wherein generating the canonicalized property address data includes parsing the property address data into a plurality of hierarchical location components and arranging the plurality of hierarchical location components in a predetermined hierarchical order to generate a hierarchical location encoding, and
wherein applying the salting operation includes applying the salting operation to a combination of the hierarchical location encoding and the normalized geospatial location data to generate the salted property address data.

12. The method of claim 1, wherein generating the cryptographic binding value further includes:
generating a canonical binding input corresponding to the confirmed unified property metadata profile by combining a canonical representation of the unique property identifier and a canonical representation of the confirmed structured device dataset in a predetermined ordering;
excluding one or more non-deterministic fields that vary across transmissions while including the unique property identifier and the confirmed structured device dataset; and
applying the cryptographic hash function to the canonical binding input to generate the cryptographic binding value.

13. The method of claim 1, wherein storing the confirmed unified property metadata profile and the cryptographic attestation further includes:
storing the confirmed unified property metadata profile and the cryptographic attestation as an immutable point-in-time artifact in an append-only storage configuration; and
maintaining a tamper-evident history of stored point-in-time artifacts associated with the unique property identifier.

14. The method of claim 1, wherein generating, with the at least one processor, the cryptographic binding value further includes:
generating one or more component digests for one or more portions of the confirmed structured device dataset;
combining the one or more component digests into an aggregate digest; and
generating the cryptographic binding value based on the aggregate digest and the unique property identifier.

15. The method of claim 1, wherein the user input includes a participant confirmation event including an affirmative confirmation action by a property participant confirming the structured device dataset, and wherein the cryptographic attestation is generated only after receipt of the participant confirmation event.

16. The method of claim 15, wherein the participant confirmation event includes a confirmation timestamp recording a date and time of the affirmative confirmation action and a confirmation method identifier identifying a modality of the affirmative confirmation action, and wherein the confirmation timestamp and the confirmation method identifier are included as data fields within the cryptographic attestation and are cryptographically bound thereto such that subsequent validation of the digital signature verifies the confirmation timestamp and the confirmation method identifier.

17. The method of claim 1, wherein the receiving of the structured device dataset, the generating of the confirmed structured device dataset and the confirmed unified property metadata profile, the generating of the cryptographic attestation, and the storing of the confirmed unified property metadata profile and the cryptographic attestation define a first capture session associated with the unique property identifier, and wherein a subsequent capture session associated with the same unique property identifier includes subsequently receiving a subsequent structured device dataset associated with the one or more property-associated electronic devices located at the real estate property, generating a subsequent confirmed structured device dataset and a subsequent confirmed unified property metadata profile including the same unique property identifier, generating a subsequent cryptographic attestation for the subsequent confirmed unified property metadata profile, and storing the subsequent confirmed unified property metadata profile and the subsequent cryptographic attestation, wherein the subsequent cryptographic attestation includes a reference to, or a cryptographic hash of, the cryptographic attestation, such that the subsequent cryptographic attestation is cryptographically linked to the cryptographic attestation and the cryptographic attestation and the subsequent cryptographic attestation form a verifiable lifecycle record associated with the unique property identifier across ownership transfers of the real estate property.

18. The method of claim 1, wherein a capture session associated with the structured device dataset comprises a first authorization stage in which a property participant grants network access to a hardware scanner node thereby enabling RF-based detection of wireless signal emissions, and a second authorization stage in which the property participant confirms the structured device dataset prior to generation of the cryptographic attestation.

19. A system for generating a cryptographically verifiable property-associated electronic device metadata record for a real estate property, comprising:
at least one processor configured to:
receive a structured device dataset including device metadata associated with one or more property-associated electronic devices located at the real estate property;
identify or retrieve a unique property identifier for the real estate property;
generate a unified property metadata profile including the unique property identifier and the structured device dataset;
provide the unified property metadata profile to at least one user device;
receive, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof;
generate, based on the user input, a confirmed structured device dataset and a confirmed unified property metadata profile including the confirmed structured device dataset and the unique property identifier;
generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value;
generate a digital signature over the cryptographic binding value for the confirmed unified property metadata profile using a private cryptographic key to produce a cryptographic attestation that binds the confirmed structured device dataset to the unique property identifier; and
store the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.

20. The system of claim 19, further comprising:
a hardware scanner node deployed at the real estate property, the hardware scanner node including at least one wireless communication interface configured to receive wireless signal emissions within a reception range of the at least one wireless communication interface, wherein the hardware scanner node is configured to:
scan, using the at least one wireless communication interface, for wireless signal emissions associated with one or more property-associated electronic devices located at the real estate property;
detect the one or more property-associated electronic devices based on the received wireless signal emissions;
extract, from the received wireless signal emissions, device metadata associated with the one or more property-associated electronic devices;
generate the structured device dataset including the device metadata associated with the one or more property-associated electronic devices; and
provide the structured device dataset to the at least one processor.

21. A computer program product comprising at least one non-transitory computer-readable medium including program instructions for generating a cryptographically verifiable property-associated electronic device metadata record for a real estate property that, when executed by at least one processor, cause the at least one processor to:
receive a structured device dataset including device metadata associated with one or more property-associated electronic devices located at the real estate property;
identify or retrieve a unique property identifier for the real estate property;
generate a unified property metadata profile including the unique property identifier and the structured device dataset;
provide the unified property metadata profile to at least one user device;
receive, from the at least one user device, a user input associated with the structured device dataset, the user input including at least one of the following: a confirmation of at least one desired property-associated electronic device of the one or more property-associated electronic devices in the structured device dataset, a request to remove at least one undesired property-associated electronic device of the one or more property-associated electronic devices in the structured device dataset, a request to add at least one additional desired property-associated electronic device to the one or more property-associated electronic devices in the structured device dataset, or any combination thereof;
generate, based on the user input, a confirmed structured device dataset and a confirmed unified property metadata profile including the confirmed structured device dataset and the unique property identifier;
generate a cryptographic binding value for the confirmed unified property metadata profile by applying a cryptographic hash function to at least the unique property identifier and the confirmed structured device dataset in combination, such that modification of either the unique property identifier or the confirmed structured device dataset results in a different cryptographic binding value;
generate a digital signature over the cryptographic binding value for the confirmed unified property metadata profile using a private cryptographic key to produce a cryptographic attestation that binds the confirmed structured device dataset to the unique property identifier; and
store the confirmed unified property metadata profile and the cryptographic attestation for the confirmed unified property metadata profile such that subsequent validation of the digital signature using a corresponding public cryptographic key verifies integrity of both the confirmed structured device dataset and the unique property identifier.
